(19) United States
(12) Patent Application Publication
(10) Pub. No.: US 2007/0246689 A1
(43) Pub. Date: Oct. 25, 2007

(54) Transparent thin polythiophene films having improved conduction through use of nanomaterials

(76) Inventors: Jiaxin Ge, Audubon, PA (US); Brij Singh, North Royalton, OH (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/784,791

(22) Filed: Apr. 10, 2007

Related U.S. Application Data
(60) Provisional application No. 60/790,967, filed on Apr. 11, 2006.
(60) Provisional application No. 60/790,690, filed on Apr. 10, 2006.

(51) Int. Cl. H01B 1/12

(52) U.S. Cl. 252/500

(57) ABSTRACT

Optically transparent, conductive polymer compositions and methods for making them are claimed. These conductive polymer compositions comprise an oxidized 3,4-ethylenedioxythiopene polymer, a polysulfonated styrene polymer, single wall carbon nanotubes and/or metallic nanoparticles. The conductive polymer compositions can include both single wall carbon nanotubes and metallic nanoparticles. The conductive polymer compositions have a sheet resistance of less than about 200 Ohms/square, a conductivity of greater than about 300 siemens/cm, and a visible light (380-800 nm) transmission level of greater than about 50%, preferably greater than about 85% and most preferably greater than about 90% (when corrected for substrate). The conductive polymer compositions comprising single wall carbon nanotubes are made by mixing the oxidized 3,4-ethylenedioxythiopene polymer and polysulfonated styrene polymer with single wall carbon nanotubes and then sonicating the mixture. The conductive polymer compositions comprising metallic nanoparticles are made by a process of in situ chemical reduction of metal precursor salts.

### CROSS REFERENCE

This application claims the priority filing date of U.S. Provisional Application Ser. Nos. 60/790,967 and 60/790,690, both filed on Apr. 11, 2006, and each herein incorporated by reference.

### FIELD OF THE INVENTION

This invention relates to conductive polythiophene-based polymers comprising single wall carbon nanotubes and/or metallic nanoparticles and processes for making same. More particularly, this invention is directed to enhancing electrical conductivity and reducing sheet resistance of polythiophene-based polymers through the incorporation of conductive nanomaterials.

### BACKGROUND OF THE INVENTION

Polymers that conduct electricity are used in a variety of applications including, among others, antistatic and electrostatic coatings. Durable, conductive thin film coatings, conductive dispersions, conductive inks, and conductive electrodes are known in the art and have been used on various substrates, including on flexible plastic substrates such as polyethyleneterephthalate (PET), polyethylenenaphthalate (PEN), co-polyesters, polycarbonate (PC), polyethersulfone (PES), polyetherketone (PEK), polymethyl methacrylate (PMMA), and tri- (di-) cellulose acetates. Conductive flexible plastic substrates are used in both the passive mode and active mode for various applications, including, among other things, flexible liquid crystal displays, solar cells, OLED, PLED, fuel cells, touch panels, EMI shielding, sensors, and other electro-optical devices. Generally, electrically conductive polymers are coated as a film on these substrates. The thickness of conductive polymer film depends upon the ultimate application.

The electrical conductivity of a polymer coating is one consideration when selecting a polymer for a particular application to a substrate. When selecting a polymer coating for use in electro-optical display type applications, the transparency of the film formed from the electrically conductive polymer is an additional, important consideration. Highly transparent, conductive thin film polymer coatings are especially desirable for flexible conductive plastic substrates in active or passive mode for various applications, such as flexible liquid crystal displays and touch panels.

Optically transparent and highly conductive materials for use as thin film coatings in electro-optical applications are known in the art. One, in particular, indium tin oxide (ITO), has been widely used and is often the conductive material of choice for a variety of electro-optical devices, such as for example flat panel liquid crystal displays and solar cells. Films of ITO can be readily imposed on glass and plastic substrates by using sputtering coating techniques. On plastic substrates, the inherent brittleness of ITO severely limits film flexibility. In addition, ITO adhesion to plastic substrates is not very good, as compared to the ITO adhesion to glass substrates, and the poor adhesion results in flaking of the polymer coating when the substrate is flexed.

Thin films comprised of conductive polymers and carbon nanotubes on flexible plastic substrates are of particular interest due to their potential high optical transparency and electrical conductivity. Eikos and others have reported that single wall carbon nanotube (SWNT)-based conductive thin film wet coating technology has been developed for flexible plastic substrates. Interestingly, the SWNT bundle-coated layer on plastic substrates functions as an alternative to ITO. However, the dispersion of single walled carbon nanotubes (SWNTs) is a challenge in mass production, due to the high cost of scale up and low uniformity and reproducibility. Moreover, if the loading percentage of SWNT's is high, the cost of production is very high, thus making commercialization not feasible.

Polythiophenes are often used to form electrically conductive polymers. EP Patent No. 339,340, and U.S. Pat. No. 4,910,645 disclose method(s) of developing a new polythiophene derivative, poly(3,4-ethylenedioxythiophene) (abbreviated as PEDOT), having the backbone structure shown below:

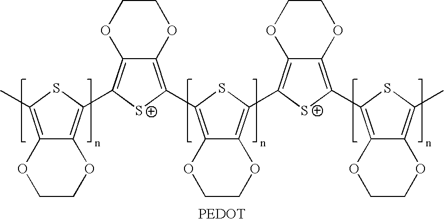

Using standard oxidative chemical or electrochemical polymerization methods, PEDOT was initially found to be an insoluble polymer, yet exhibited some very interesting conducting properties when used as a solid electrolyte in electrolyte capacitors. In addition to a very high conductivity, PEDOT was found to be highly transparent when used as a thin, oxidized film and showed a very high stability in the oxidized state. The solubility problem was subsequently resolved by using a water-soluble cationic polyelectrolyte, polystyrene sulfonic acid (PSS), as the charge-balancing dopant during polymerization to yield PEDOT/PSS. This combination resulted in a water-dispersible polyelectrolyte system with good film forming properties, high conductivity, high visible light transmission, and excellent stability. However, the electrical conductivity of PEDOT/PSS systems remains to be further improved to meet the requirements for different applications in electro-optical devices, in order to serve as an ITO replacement.

Both Bayer AG (or HC Starck) and Agfa have developed PEDOT/PSS conductive polymer coating dispersions suitable for wet chemical coatings in mass production. These PEDOT/PSS polymer systems are optically transparent and have a finite electrical conductivity. They are useful in the aforementioned applications for flexible conductive plastic substrates. However, their electrical conductivity is still not high enough to meet all of the requirements for electro-optical devices. Therefore, there is still a need for improvement in the electrical conductivity of conductive PEDOT/PSS polymer thin film coatings for use in electro-optical applications.

The present invention relates to ways to enhance the electrical conductivity of known PEDOT/PSS polymer systems, while still retaining their transparency, which is highly desirable in electro-optical applications. Generally, the target performance for an optically transparent conductive thin film coating is a lower sheet resistance of < about 200 Ohms/sq. at a high visible light (380-800 nm) optical transmittance level (>85%-90%, preferably >90%, when corrected for substrate). Desirable coatings are capable of being uniformly deposited using wet chemical processes, such as screen printing or ink-jet printing techniques, rather than the more expensive and less uniform sputtering or other vacuum deposition methods, as used with ITO.

In order to improve further the electrical conductivity of PEDOT/PSS systems, new enhancement approaches are needed. Accordingly, this invention is directed to the improvement of the electrical conductivity of transparent thin film coatings comprising PEDOT/PSS by incorporation of low levels of nanomaterials, such as carbon nanotubes and/or metallic nanoparticles. It is believed that the nanomaterials attach to the conductive PEDOT/PSS nanowire chains to enhance the hopping (mobility) of localized electrons among neighbouring polymer chains to improve the electrical conductivity of PEDOT/PSS thin film compositions. This invention is also directed to a process comprising the in-situ chemical reduction of metal precursor salts to form metallic nanoparticles in PEDOT/PSS conductive polymer dispersions, including without limitation in-situ chemical reduction in formulated conductive polymer dispersions containing PEDOT/PSS among other things. The resulting hybrid (PEDOT/PSS/nanoparticles) conductive polymer dispersions meet the requirements for electro-optical display applications with lower energy consumption.

It is an object this invention to enhance the electrical conductivity or reduce the sheet resistance of PEDOT/PSS polymer systems through the incorporation of low levels of conductive metallic nanoparticles (e.g., Au, Ag, Pt) and other conductive nanomaterials, such as single wall carbon nanotubes (SWNT's), into conductive polymer dispersions. Specifically, it is an object of this invention to meet the low sheet resistance (< about 200 Ohms/sq.) and high (>85%, preferably >90%, when corrected for substrate) optical transparency requirement of the different electro-optical applications, including but not limited to, flexible liquid crystal displays, touch panels and flexible electrodes.

A further object of this invention is to produce newly designed hybrid conductive PEDOT/PSS-based polymers having improved electrical conductivity, reduced sheet resistance and excellent optical transparency to be utilized as a replacement for ITO.

A further object of this invention is to enhance the hopping of localized electrons to improve the electrical conductivity (electron mobility) of PEDOT/PSS thin film compositions, so as to meet the requirements for different electro-optical applications, including, but not limited to, flexible liquid crystal displays, touch panels and flexible electrodes, using wet chemical coatings or ink-jet printing techniques.

A further object of this invention is to provide a process to incorporate metallic nanoparticles into PEDOT/PSS dispersions by using in-situ chemical reduction methods to preserve high optical transparency, which has not been reported before.

Another object of this invention is to develop a new approach towards the improvement in electrical conductivity of conductive polymers comprising PEDOT/PSS while maintaining their high optical transparency.

Yet another object of this invention is to replace ITO on flexible plastic substrates using wet chemical coatings, screen printing or ink-jet printing techniques or other techniques such as roll-to-roll coatings, even to replace ITO on glass substrates using simple ink-jet printing techniques to eliminate the chemical etching in complicated patterning processes in a cost effective way.

### SUMMARY OF THE INVENTION

The claimed invention provides novel conductive polymer compositions and methods for making them. These conductive polymer compositions comprise an oxidized 3,4-ethylenedioxythiopene polymer (PEDOT), a polysulfonated styrene polymer (PSS), and metallic nanoparticles and/or single wall carbon nanotubes (SWNT's). The PEDOT/PSS polymers are combined with metallic nanoparticles and/or SWNT's such that the resulting conductive polymer composition has a sheet resistance of less than about 200 ohms/square (Ohms/sq.), a conductivity of greater than about 300 siemens/cm (S/cm), and a visible light transmission of greater than about 50% (preferably >85-90%, most preferably >90% (when corrected for substrate)) at a wavelength ranging from about 380 to about 800 nm. As should be clear, the invention contemplates conductive polymer compositions comprising either metallic nanoparticles or SWNT's, or both.

In one embodiment, conductive PEDOT/PSS polymer compositions comprising single wall carbon nanotubes are made by intimately mixing the PEDOT/PSS polymer composition with single wall carbon nanotubes through sonication. Specifically, poly 3,4-ethylenedioxy-thiopene (PEDOT), polysulfonated styrene (PSS), and single wall carbon nanotubes are combined in a solvent system to form a mixture, followed by sonication of the mixture for about 15 to 60 minutes. The resulting hybrid conductive polymer contains low levels of single wall carbon nanotubes dispersed throughout the PEDOT/PSS polymer matrix.

In another embodiment, the conductive PEDOT/PSS polymer compositions comprising metallic nanoparticles are made by in situ chemical reduction. This in situ chemical reduction involves combining an oxidized poly 3,4-ethylenedioxythiopene (PEDOT), a polysulfonated styrene (PSS), and metallic nanoparticle precursor molecules in a solvent system, followed by adding a reducing agent. The reducing agent selectively reduces the metallic nanoparticle precursor, but not the oxidized PEDOT/PSS polymer, thereby forming the metallic nanoparticles.

### BRIEF DESCRIPTION OF THE DRAWINGS

The invention will be better understood and other features and advantages will become apparent by reading the detailed description of the invention, taken together with the drawings, wherein:

FIG. 1 is a representation of the chemical structure of a 3,4-ethylenedioxy-thiopene/poly(sulfonated styrene) polymer composition.

FIG. 2 is a transmission electron microscopy image of SWNT's distributed in the conductive polymer composition of Example 1. The outer diameter of functionalized SWNT/PSS was controlled within 5 to 50 nm, with elongated tubular shapes.

FIG. 3 is a plot of light transmittance vs. wavelength for the conductive polymer composition of Example 1.

FIG. 4 is a transmission electron microscopy image of the SWNT's and Au nanoparticles distributed in the conductive polymer composition of Example 3. The outer diameter of the functionalized SWNT/PSS was controlled within 5-40 nm, while the size of the Au nanoparticles was controlled within 5-20 nm.

FIG. 5 is a plot of light transmittance vs. wavelength for the conductive polymer composition of Example 3.

FIG. 6 is a plot of light transmittance vs. wavelength for the conductive polymer composition of Example 5.

FIG. 7 is a transmission electron microscopy image of Ag nanoparticles distributed in the conductive polymer composition of Example 6. The size of the Ag nanoparticles was controlled within 5-30 nm, with more or less spherical shape.

FIG. 8 is a plot of light transmittance vs. wavelength for the conductive polymer composition of Example 6.

FIG. 9 is a transmission electron microscopy image of Au nanoparticles distributed in the conductive polymer composition of Example 7. The size of the Au nanoparticles was controlled within 10-20 nm, with more or less spherical shape.

FIG. 10 is a plot of light transmittance vs. wavelength for the conductive polymer composition of Example 7.

FIG. 11 is a transmission electron microscopy image of Pt nanoparticles distributed in the conductive polymer composition of Example 8. The size of the Pt nanoparticles was controlled within 3-10 nm, with more or less spherical shape.

FIG. 12 is a plot of light transmittance vs. wavelength for the conductive polymer composition of Example 8.

FIG. 13 is a transmission electron microscopy image of Au nanoparticles distributed in the conductive polymer composition of Example 9.

FIG. 14 is a plot of light transmittance vs. wavelength for the conductive polymer composition of Example 9.

FIG. 15 is a transmission electron microscopy image of Ag nanoparticles distributed in the conductive polymer composition of Example 10.

FIG. 16 is a plot of light transmittance vs. wavelength for the conductive polymer composition of Example 10.

### DETAILED DESCRIPTION OF THE INVENTION

The conductive polymer compositions of the present invention comprise an oxidized 3,4-ethylenedioxythiopene polymer (PEDOT), a polysulfonated styrene polymer (PSS), and single wall carbon nanotubes (SWNT's) and/or metallic nanoparticles. These conductive polymer compositions have a sheet resistance of less than about 200 Ohms/sq., a conductivity of greater than about 300 siemens/cm, and a visible light transmission of greater than about 50% (preferably >85-90%, most preferably >90% (when corrected for substrate)) at a wavelength ranging from about 380 to about 800 nm. The present conductive polymer compositions provide decreased sheet resistance, increased conductivity, and similar visible light transmission as compared to PEDOT/PSS compositions without SWNT's and/or metallic nanomaterials.

This description, including the examples set forth herein, are intended to meet the requirements of written description, enablement, and best mode, without imposing limitations on the scope of the invention(s), which are not recited in the claims.

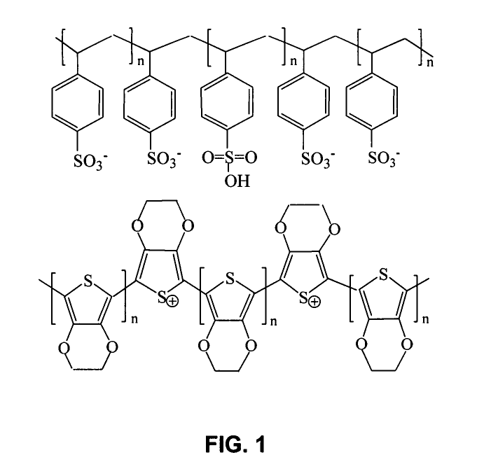

PEDOT can be synthesized by combining a 3,4-ethylenedioxythiopene monomer in solution with iron (III) p-toluenesulfate, in organic solvents such as isopropanol or ethanol. Upon polymerization, an iron salt precipitate appears that can be removed by aqueous washing. The resulting conductive polymer can thus be provided as an aqueous dispersion. The aqueous dispersion of the conducting polymer can then be stabilized by including polystyrene sulfonic acid (PSS), i.e., polysulfonated styrene, which serves as a colloid stabilizer. In certain conditions, the polysulfonated styrene can also serve as a binder, as discussed below. The structure and synthesis of PEDOT and similar conductive polymers is disclosed in U.S. Pat. No. 5,035,926, which is hereby incorporated by reference. A representative chemical structure of a poly 3,4-ethylene-dioxythiopene/polysulfonated styrene polymer composition (PEDOT/PSS) is shown in FIG. 1.

PEDOT/PSS compositions are commercially available. Generally, the ratio of PEDOT to PSS in the PEDOT/PSS composition is not critical to the claimed invention. The present inventions can be applied to various commercially available or prepared PEDOT to PSS ratios and still achieve enhancement of electrical conductivity properties. Commercially available PEDOT/PSS compositions, such as the Baytron series, have PEDOT to PSS ratios ranging from about 1 to about 2.5 by weight. Any PEDOT/PSS composition or formulation comprising PEDOT/PSS may be utilized in the invention(s) described herein, and all ratios of PEDOT to PSS are intended to be within the scope of the invention.

The optically transparent, conductive polymers of the invention can be used as films or coatings on various substrates including polymers and ceramics. Examples of suitable polymer substrates include, but are not limited to, polycarbonates, polyamides, polyethylenes and polypropylenes. Examples of flexible plastic substrates include, but are not limited to, poly(ethylene terephthalate), poly(ethylene naphthalate), copolyesters, polyethersulfone, polyether-ketone, polymethyl methacrylate, and tri- or di-cellulose acetates, and copolymers of any of the above. Examples of suitable ceramic substrates include, but are not limited to, aluminum oxide, silicon dioxide, and glass. The conductive polymers are applied to substrates by various techniques, including brushing, printing, bar coating, dip coating, spin coating, solution or dispersion coating, roller coating, or spraying. Once the polymer is coated onto a substrate, the solvent is dried off to form a thin, conductive polymer film. Solvent evaporation can occur at room temperature, or the rate of solvent evaporation can be increased by applying heat.

Binders other than PSS, or in addition to PSS, can be used with PEDOT and other conductive polymers and are considered to be within the scope of the invention. Binders are used to improve the adhesion of the conductive polymer to a substrate. Examples of useful binders include, but are not limited to polyvinyl acetate, polycarbonate, polyvinyl butyrate, polyacrylates, polymethacrylates, polystyrene, polysulfonated styrene, polyacrylonitrile, polyvinyl chloride, poly-butadiene, poly-isoprene, polyethers, polyesters, silicones, pyrolle/acrylate, vinyl acetate/acrylate, ethylene/vinyl acetate copolymers, polyvinyl alcohols, and any derivatives or mixtures thereof. Binders, when used in the compositions of the invention, are present in small amounts sufficient to bind diverse substrates, as one skilled in the art would understand.

PEDOT/PSS compositions are commercially available from several sources including H.C. Starck, GmbH. (Goslar, Del.). The H.C. Starck PEDOT/PSS compositions are known under the tradename Baytron®. Many Baytron® PEDOT/PSS compositions are available as aqueous dispersions. Agfa-Gevaert NV (Mortsel, Belgium) also makes commercially available PEDOT/PSS compositions. The Agfa compositions are sold under the tradename New Spin™ and are also available as aqueous dispersions. The sheet resistance, conductivity and visible light transmission for films made from several of these commercially available PEDOT/PSS compositions are listed in Table 1.

Single wall carbon nanotubes (SWNT's) useful in the inventive conductive polymer compositions can be made from a variety of techniques, such as, formation in electric fields (e.g., such as by an electric arc), laser evaporation of carbon, and using concentrated solar energy to vaporize carbon. Examples of several carbon nanotube synthesis techniques are disclosed in U.S. Pat. Nos. 5,227,038; 5,300,203; 5,556,517; and 5,591,312, which are hereby incorporated by reference. Useful single wall carbon nanotubes can be obtained commercially from Carbon Nanotechnology Inc. (Houston, Tex.).

The single wall carbon nanotubes are purified prior to use to remove catalysts and other impurities, such as iron catalysts and amorphous carbons. For purposes of the present invention, purification involves the steps of (1) heating the single wall carbon nanotubes to high temperatures in an oxidizing atmosphere, (2) treating the single wall carbon nanotubes with strong acids under sonication, and (3) washing the single wall carbon nanotubes. In another embodiment, the purification method involves treating the single wall carbon nanotubes with strong acids under sonication and washing the single wall carbon nanotubes (i.e., no heating program).

For purification methods involving heating, examples of static heating programs include heating at a temperature between about 200° C. and about 500° C., or between about 400° C. and about 500° C. Examples of heating ramps include heating ramps from about 200° C. and about 500° C., or from about 200° C. and about 435° C., or from about 200° C. and about 425° C. Equipment and methods of heating are well known in the art.

The length of time for heating, if used, ranges from about 0.5 hours to about 4 hours, or about 1 hour to about 3 hours, or about 1 hour to about 2 hours. The length of time for sonication ranges from about 0.5 hours to about 3 hours or about 1 hour to about 2 hours. Examples of strong acids used in the sonication step include H₂SO₄, HNO₃, HCl, and mixtures thereof.

The single wall carbon nanotubes may be washed with acidic solutions such as, but not limited to, solutions of H₂SO₄, HNO₃, HCl, and mixtures thereof. The single wall carbon nanotubes can also be washed with solvents such as, but not limited to water, tetrahydrofuran, isopropyl alcohol, acetone, and mixtures thereof.

Other techniques for the removal of impurities from single wall carbon nanotubes are known. Examples of additional purification techniques are described in U.S. Pat. Nos. 6,752,977 and 6,936,233, which are hereby incorporated by reference. Purification levels can be checked by transmission electron microscopy (TEM). TEM shows that iron catalyst can be effectively removed using these techniques leaving single wall carbon nanotubes that are free of iron.

The single wall carbon nanotubes can be treated to add functional groups to their surfaces. Surface functional groups can, in certain chemical environments, improve the interaction of a carbon nanotube with a nearby molecule. Useful surface functional groups include, but are not limited to, carboxyl, hydroxyl, hydrogen sulfite, nitrite, amine, and mixtures thereof. Variations of single wall carbon nanotubes can be derived using known methods, such as the techniques disclosed in U.S. Pat. Nos. 6,645,455 and 6,835,366, which are hereby incorporated by reference. The degree of functionalization of a single wall carbon nanotube can be monitored by IR spectroscopy, i.e., absorbance of moieties on the functional groups, such as —OH and —COOH.

Without wishing to be bound by theory, it is believed that the SWNT's are dispersed throughout the PEDOT/PSS matrix through interactions with the PSS polymer. Specifically, it is believed that selectively strong interactions between PSS polymers and the basal plane of the purified SWNT's allows the PSS polymers to physically wrap around the surface of the SWNT's through π-π stacking interactions. The unique physical wrapping structure formation is believed to further enhance the dispersion ability of the SWNT in water or solvents. These PSS/SWNT molecules then interact with PEDOT/PSS molecules through the phenylene units of the PSS polymers creating additional π-π stacking interactions. It is further believed that the matrix of additional π -π stacking interactions and the network of the SWNT's act to improve the conductivity of the PEDOT/PSS/SWNT polymer, as compared to the PEDOT/PSS polymer, while maintaining a high level of visible light transmission. Surface functionalized SWNT's, as described above, can depending on functionalization, enhance the interactions between the SWNT's and PSS.

Single wall carbon nanotubes useful in the compositions of the invention have a typical bundle size of 5-50 nm, preferably 2-20 nm. Loading percentages for single wall carbon nanotubes combined in PEDOT/PSS dispersions can vary. The amounts must be kept low to preserve film clarity. The amounts of single wall carbon nanotubes disclosed in the examples are believed to be optimized; however, other amounts may be used and enhanced properties may still be achieved.

The metallic nanoparticles used in the present conductive polymer composition are prepared from precursor metal salts including, but not limited to, salts of gold, silver, platinum, palladium, cobalt, copper, nickel, aluminum, and mixtures thereof. Particularly useful metal salts include AgNO₃, HAuCl₄, Na₂PtCl₄, and mixtures thereof. Aqueous solutions of the metal salts are combined with a reducing agent to form metal ions in solution, and the ions then aggregate to form nano-sized metallic particles (metallic nanoparticles).

Without wishing to be bound by theory, it is believed that strong interactions between the sulfur atom in the polythiophene units of PEDOT/PSS and, for example, the gold, silver and copper metal nanoparticle surfaces allow for the formation of physical or even chemical bonding between the sulphur atom and the metallic nanoparticle surfaces. The interactions between the S in polythiophene units and other metallic nanoparticle surfaces (such as Pt, Pd, Al) may be weaker. Nonetheless, enhancement of electrical conductivity has been observed in formulated PEDOT/PSS/Pt nanoparticle systems. Without being bound by theory, it is further believed that the large nanoparticle surfaces of the metal aggregates can be further stabilized by the functional conductive polymer long chains. The resulting interconnected structure leads to the unique enhancement of localized electron hopping and increased electrical conductivity of the PEDOT/PSS.

The metallic nanoparticles useful in the compositions of the invention have a typical size ranging from 2 to 50 nm, but less than 100 nm. Preferably, the size range is from about 2 to 20 nm. The metallic nanoparticles are dispersed throughout the PEDOT/PSS polymer matrix in various amounts. As with SWNT's, the amount of metallic nanoparticles must be kept low to preserve film clarity. Amounts disclosed in the examples are believed to be optimized; however, other amounts are within the scope of the invention.

Depending on their specific identity, the metallic nanoparticles are strongly bound to the PEDOT/PSS polymer as described above. For example, gold, silver and copper nanoparticles have strong interactions with the sulfur atoms of the PEDOT/PSS polymer. The metallic nanoparticles improve the conductivity of the PEDOT/PSS, as compared to the base, unmodified PEDOT/PSS polymer, while maintaining a high level of visible light transmission.

Optionally, additional conductive polymer compositions comprise oxidized 3,4-ethylenedioxythiopene polymers and polysulfonated styrene polymers in combination with both SWNT's and metallic nanoparticles. The individual interactions between the PEDOT/PSS molecules and the SWNT's and nanoparticles discussed above would not change. Useful SWNT's and metal nanoparticles, particle sizes, and ranges are also as described above.

The sheet resistance (R_{S}) of a polymer film is a function of the bulk resistivity of the film and the film thickness. Sheet resistance is described in units of ohms/square (Ω/□ or Ohms/sq.), where “square” is dimensionless. Sheet resistance is often measured using a four-point probe, in which a DC current is applied between two outer current electrodes and a voltage is measured between two inner electrodes located within the two outer electrodes. Four-point probes utilize a geometric correction factor based on the orientation and spacing of the electrodes in the probe to correct the voltage/current ratio measured by the probe. The resistivity of a film can be calculated from the sheet resistance by multiplying the sheet resistance by the thickness (t) of the film. The inventive conductive polymer composition has a sheet resistance of less than about 200 Ohms/square, preferably less than about 175 Ohms/square, more preferably less than about 150 Ohms/square, or most preferably less than about 100 Ohms/square.

The conductivity (σ) of a polymer composition is the measure of the electrical conduction of the material. Conductivity measurements are reports in siemens per cm (siemens/cm or S/cm). Conductivity can be measured, for example, by applying a differential electrical field across a conductor and monitoring the electrical current that results. The conductivity is then calculated by dividing the current density by the strength of the applied electric field. Conductivity is the reciprocal of electrical resistivity, thus conductivity can be calculated from sheet resistance by taking the reciprocal of the sheet resistance multiplied by the film thickness (σ=1/(R_{S}×t). The inventive conductive polymer composition has a conductivity of greater than about 300 siemens/cm, preferably greater than about 450 siemens/cm, more preferably greater than about 600 siemens/cm, and most preferably greater than about 750 siemens/cm. One preferred embodiment has conductivity preferably greater than about 900 siemens/cm.

The visible light transmission level of a polymer composition is the intensity level of light at a particular wavelength passing though a sample. The visible light transmission level is usually presented as a percentage value reflecting the intensity of the light that passes through the sample divided by the intensity of the light without the sample. Visible light intensity can be measured, for example, by a BYK-Gardner Haze-Gard Plus Transmission Meter, Model 4725. For purposes of this invention, “visible light wavelength” is between 380 and 800 nm. The conductive polymer compositions of the invention have a visible light (380-800 nm) transmission level in a range of about 50% to about 100%. Preferably, the visible light transmission level for the conductive polymer compositions (when corrected for substrate) is greater than about 70%, more preferably greater than about 80%, or most preferably greater than about 90%. In order to have a high optical transparency in the whole visible light region (from 380 nm to 780 nm), the dispersion of the nanoparticles should be very uniform, along with a controlled size of the nanoparticles of less than about 40 nm. No significant absorption of the hybrid conductive thin film coatings has been detected in the whole visible light region (from 380 nm to 800 nm) from conductive metal nanoparticles and other nanomaterials due to the complete dispersion of nanomaterials.

Optionally, an anti-reflective coating may be used on the outer side of a coating made from the conductive polymers of the invention, to improve the visible light transmission level. An anti-reflective coating acts to reduce the reflection at the surface, allowing a higher level of visible light transmission. Typically, anti-reflective coatings include several different sub-layers comprising many different materials such as, but not limited to, Al₂O₃, ZrO₃, MgF₂, SiO₂, cryolite, LiF. ThF₄, CeF₃, PbF₂, ZnS, ZnSc, Si, Te, MgO, Y₂O₃, Sc₂O₃, SiO, HfO₂, ZrO₂, CeO₂, Nb₂O₃, Ta₂O₅, and TiO₂. The thickness of each sublayer is often related to an even whole number division of the wavelength of light that is most preferred to be transmitted through the coated material.

Anti-reflective coatings are well known in the art and information on designing and depositing anti-reflective layers on objects can be found in such references as the Handbook of Optics (McGraw Hill, 2^{nd} Ed.), and Design of Optical Interference Coatings (McGraw Hill), which are hereby incorporated by reference. Typical sublayer thicknesses required to achieve a particular visible light transmission level are also known in the art.

The PEDOT/PSS/nanomaterial (using SWNT's, metallic, or both) polymer compositions of the present invention are made using methods specific to the type of conductive nanomaterial employed. PEDOT/PSS/metallic nanoparticle compositions are synthesized by in situ reduction of metal salt precursors in the presence of the PEDOT/PSS aqueous dispersion. In this synthesis, the PEDOT, PSS, and the metal salt precursors are intimately dispersed in a solvent system. A reducing agent is then added which results in metal ion formation. The metal ions aggregate to form nano-sized particles referred to as metallic nanoparticles. The formation of metallic nanoparticles is a selective reduction of the metal salt precursors. PEDOT, as described above, is already in an oxidized state and is not reduced during the selective reduction of the metal salt precursors, as evidenced by the resulting composition maintaining a high (greater than about 85%, preferably greater than 90% when corrected for substrate) visible light transmission level. Reduced PEDOT does not transmit visible light at such a high level and does not have electrical conductivity.

In one embodiment of the method, a PEDOT/PSS dispersion is mixed with a metal salt precursor (i.e., salt form of the metal) solution in a suitable reaction vessel. Then, a reducing agent, such as NaBH₄, is added to the mixture to reduce the oxidation state of the metal atoms (ions) in solution. The oxidized, conductive PEDOT/PSS polymer is not reduced. The reduced metal atoms (ions) subsequently aggregate and assemble to form nanoparticle structures. The metallic nanoparticle structures having more or less spherical shapes form directly in the PEDOT/PSS polymer and are dispersed throughout the polymer matrix. The metallic nanoparticle structures formed by this method range from about 2 nm to 50 nm, depending on the metal used and the reaction conditions. The hybrid conductive polymer compositions made by this method have lower sheet resistance and higher conductivity than their PEDOT/PSS polymer precursor, while maintaining a similar level of visible light transmission.

Suitable reducing agents for use with this method include, but are not limited to, NaBH₄, sodium citrate, hydrazine, hydroxylamine, dimethylformamide, lithium aluminum hydride, and mixtures thereof. Other useful reducing agents will be well known to one skilled in the art. The primary requirement for selection is that the reducing agent must reduce the oxidation state of the metal of the metal salt precursor, but must not reduce the oxidation state of the oxidized conductive polymer. Reducing agents are generally added to ice cold (0°-5° C.) distilled water to form a solution, which is then added to the PEDOT/PSS/metallic salt precursor mixture. Only small amounts of reducing agents are needed, and solutions are generally <1 wt. %.

PEDOT/PSS/SWNT compositions are created by sonicating a SWNT mixture in the presence of PEDOT/PSS. Alternatively, the SWNT's can be pre-mixed with PSS with sonication, and then this mixture can be added to a PEDOT/PSS dispersion and further sonicated. In these methods, sonication affects the physical wrapping of PSS polymers around the surface of the purified SWNT's. Sonication is preferred since it achieves a uniform dispersion of the SWNT's in the PEDOT/PSS polymer

In one embodiment, SWNT's are added to a PEDOT/PSS polymer mixture in a solvent. This mixture is then sonicated for a few minutes up to a few hours. A PEDOT/PSS/SWNT conductive polymer composite results from this method. As an alternative embodiment, PSS polymers and SWNT's are first mixed together in a solvent system and sonicated to form a PSS/SWNT mixture. Sonication can be performed for a few minutes up to a few hours. This PSS/SWNT mixture is then added to a PEDOT/PSS polymer dispersion. The (PEDOT/PSS)/(PSS/SWNT) mixture is then sonicated until a uniform mixture is obtained, e.g., for a few minutes up to a few hours. A PEDOT/PSS/SWNT conductive polymer results from this method. This method, for integrating SWNT's into a PEDOT/PSS polymer, can also be used to integrate SWNT's into PEDOT/PSS/metallic nanoparticle conductive polymer compositions. If both SWNT's and metallic particles are combined, SWNT's are generally added to the PEDOT/PSS/metallic nanoparticle dispersion, followed by sonication.

The solvents useful for performing these methods include, but are not limited to water, dimethylsulfone, ethylene glycol, dimethylformamide, dimethylacetamide, n-methyl pyrrolidone and mixtures thereof. As mentioned above, several of the Baytron® lines of PEDOT/PSS compositions are available as aqueous dispersions. Depending on the identity of the components of a reaction mixture, the described methods will work in aqueous or partially aqueous dispersions, so often no special preparation techniques or additional solvents are necessary for PEDOT/PSS compositions commercially available as an aqueous dispersion. Examples of suitable solvent systems for the described methods include, but are not limited to, water with a small amount of dimethyl sulfone and ethylene glycol, and water with a small amount of dimethyl sulfone. Solvents are not added to dissolve the PEDOT/PSS dispersions completely. While not wishing to be bound by theory, small amounts of solvents are used, which are sufficient to swell or soften the PEDOT/PSS conductive polymer, which results in enhanced conductivity being achieved.

The above methods are accomplished in any suitable reaction vessel, such as, for example a round-bottom flask or a three-necked round-bottom flask. Suitable reaction vessels are well known to those skilled in the art. The temperature of the reaction can be monitored if desired. One example includes inserting a thermometer through one neck of a three-necked round-bottom flask. Other methods known to those skilled in the art are equally suitable. Any solvent evaporation can be controlled, if necessary, by the use of a condensing apparatus, for example, by adding a condensing apparatus to one neck of a three-necked round-bottom flask or other reaction vessel.

The fields of application of these conductive polymers include, but are not limited to, antistatic coating of plastics, antistatic coating of glass, electrostatic coating of plastics, capacitor electrodes (tantalum and aluminum), through-hole plating of printed circuit boards (PCBs), polymer light emitting diode (LED) displays, organic light emitting diode displays, flexible liquid crystal displays, solar cells, touch panels, fuel cells, sensors, and flexible electrodes. The thickness of a conductive polymeric film depends upon the application and the desired film conductivity and transparency, but is generally at least about 20 nanometers and can range up to about 10 micrometers.

The following examples are intended for illustration purposes only and should not be construed as limitations upon the claims.

### EXAMPLES

Sample films were created by either spin-coating or dispersion-coating a conductive polymer of the invention onto either a glass or a plastic substrate. The polymer coatings were dried/cured at an elevated temperature between 80° and 120° C. for between one half hour and one hour to create a hardened film. After drying/curing, the films were cooled to ambient temperature. The films were about 30 nm to about 150 nm thick. No antireflective coating was used.

Sheet resistance measurements for the dried/cured films were obtained using a standard SYS-301 four probe method at ambient temperature. The four probe resistance method includes a Keithley Model 2000 Digital Multimeter, a Keithley Model 224 programmable current source (Keithley Instruments, Inc.; Cleveland, Ohio) combined with a Signatone SP4-62.5-85-TC four point probe head mounted in a Signatone S-301 mounting stand with a six inch Teflon® disk (Signatone Corporation; Gilroy, Calif.). The instrument was calibrated using an undoped N-type silicon wafer with a resistivity of 65.6-77.5 Ohms/sq., a diameter of 50.0-51.1 mm, and a thickness of 300±25 nm [ρ=4.53 (V/I)] (Virginia Semiconductor, Inc.; Fredericksburg, Va.).

Optical transmittance measurements as a function of wavelength were made using a Perkin Elmer Lambda 900 UV/Vis/NIR spectrophotometer in the transmission mode. The optical transmittance value in the photopic region was also measured by a BYK-Gardner Haze-Gard Plus Transmission Meter, Model 4725 using the coated dry glass or plastic substrates. The wavelength used for the optical transmittance measurements was about 540 nm.

Transmission electron microscopy (TEM) measurements were performed on a Philips TECNAI-12 TEM using a voltage of 120 kV. Samples were prepared by depositing sample dispersions onto 200 mesh carbon coated copper grids.

### Reference Conductive Polymer Examples

Each of the PEDOT/PSS conductive polymers used in the examples below was placed, in an unmodified condition (i.e., without metallic nanoparticles or SWNT's), into a similar solvent system as used in the examples, a film was formed on a substrate as described above, and physical measurements were taken for comparison purposes. Tables 1 and 3 indicate the measurement values for unmodified conductive polymers used as comparisons.

### Examples 1-5

### PEDOT/PSS/SWNT's

The first group of examples relate to conductive polymers comprising SWNT's. Examples 3-5 comprise both SWNT's and metallic nanoparticles.

Single Wall Carbon Nanotube Purification Methods

Carboxyl acid-functionalized SWNT's obtained from Carbon Nanotechnology, Inc. (Houston, Tex.) were purified using the following methods:

Purification Method I

The carboxyl acid-functionalized SWNT's were heated at 500° C. for 1 hour then a solution of 14 ml concentrated HNO₃ and 7 ml H₂SO₄ was added to the SWNT's. This acid/SWNT mixture was then sonicated for one hour. After sonication, the mixture was washed in steps. The first step was to wash with distilled water until the mixture had a pH of between about 6 and about 7 (1400 ml was used). The second step was to wash with 200 ml of tetrahydrofuran. The third step was to wash with 200 ml of acetone. And, the fourth step was to wash with 200 ml of isopropyl alcohol. Finally, the SWNT's were dried over-night at 80° C.

Purification Method II

The carboxyl acid-functionalized SWNT's were sonicated in a concentrated HCl solution for one hour. After sonication, the mixture was washed in steps. The first step was a wash with distilled water until the mixture had a pH of between about 6 and about 7 (1000 ml was used). The second step was a wash with 200 ml of isopropyl alcohol. The third step was a wash with 150 ml of tetrahydrofuran. Finally, the SWNT's were dried for two hours at 80° C. The yield for this purification method was 76%.

Purification Method III

The carboxyl acid-functionalized SWNT's were heated at 450° C. for 1.5 hours. Then, a solution of 14 ml of 37% HCl and 17 ml of H₂O was added to the SWNT's. This acid/SWNT mixture was sonicated for 1.5 hours. After sonication, the mixture was washed in steps. The first step was a wash with concentrated H₂SO₄ for one hour. The second step was a wash in 8% H₂SO₄. The third step was a wash in distilled water until the mixture had a pH of between about 6 and about 7 (1500 ml was used). The yield for this purification method was 31%.

### Example 1

### Synthesis of Baytron F HC/SWNT-Nanoparticle Composition

2.0 mg of carboxyl acid-functionalized SWNT's (Carbon Nanotechnology, Inc.; Houston, Tex.) were mixed with 40.0 g of distilled water and 0.1 g of PSS. The mixture was sonicated until a uniform SWNT suspension was formed (60-120 minutes). The SWNT's were purified as described above.

20.1 g of Baytron F HC (formulated PEDOT/PSS in an aqueous dispersion) and 1.01 g of dimethyl sulfone (DMSO) were combined at ambient temperature, with stirring, in a 250 ml three-necked round-bottom flask equipped with a condenser and a thermometer. The mixture was stirred for at least 30 minutes at ambient temperature. The SWNT purified suspension (2.01 g) was added to the mixture and sonicated for 30 minutes. The resulting mixture contained a hybrid conductive polymer comprising Baytron F HC with dispersed SWNT/PSS.

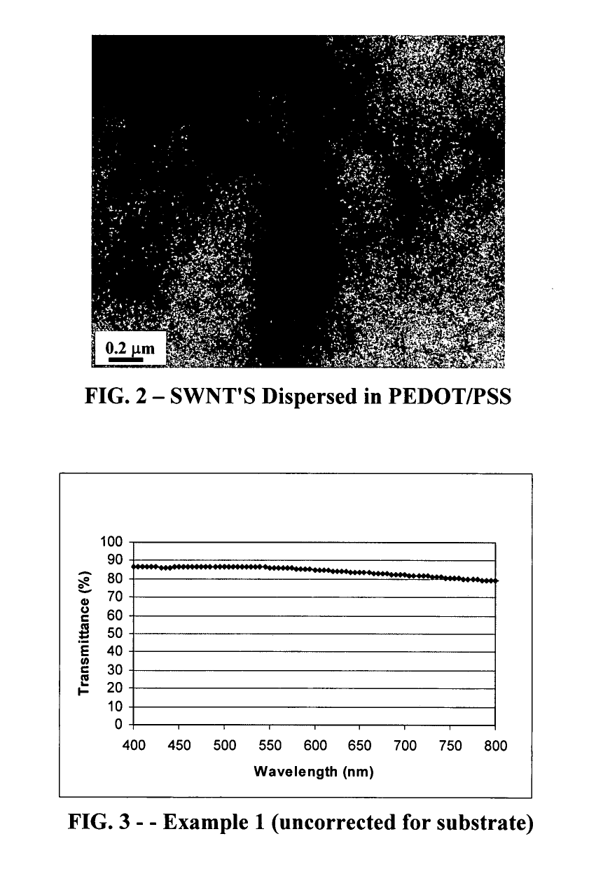

Transmission electron microscopy measurements indicated that SWNT's were well dispersed within the Baytron F HC polymer with a typical bundle size of 5 nm to 50 nm. FIG. 2 is a TEM image of a film made from the Example 1 composition, which shows the SWNT's forming elongated tubular shapes within the polymer matrix.

FIG. 3 is a UV/Vis transmission spectrum for a thin film made with this polymer, which shows that the visible light transmission level is consistently high (greater than about 80%; greater than about 90% when corrected for substrate) for the polymer of this example.

The sheet resistance of the conductive polymer (Baytron F HC) modified with the same DMSO/EG was about 620-680 Ohms/sq. (or 595-635 Ohms/sq.) at the visible light transmission of 85.3% (or 84.7%). The estimated electrical conductivity of modified Baytron F HC was about 210-230 S/cm. However, the sheet resistance of the newly designed hybrid conductive polymer composite (Baytron F HC-Ag NP) was improved to 450-490 Ohms/sq. (or 390-450 Ohms/sq.) at the visible light transmission of 85.3% (or 84.6%). The calculated electrical conductivity of hybrid Baytron F HC-Ag NP was improved to at least 300-340 S/cm.

Table 2 below contains the physical property measurement results for a film made with the hybrid conductive polymer of this example. As can readily be seen from a comparison of the sheet resistance, calculated electrical conductivity, and visible light transmission of the synthesized polymer (Table 2) to the values for the unmodified polymer precursor (Table 1), both the sheet resistance and calculated electrical conductivity were improved and the visible light transmission was not greatly impacted.

TABLE 1
Reference/Comparison Examples of Unmodified Conductive Polymers

| | Sheet | | |
|---|---|---|---|
| | Resistance | Conductivity | Visible Light |
| Compound^{a} | (Ω/□) | (S/cm) | Transmission (%)^{d} |
| Baytron F HC | 620-680 | ˜210-230 | 85.3 |
| in DMSO/EG^{b} | (585-635)^{c} | | (84.7)^{c} |
| Baytron P HC | 280-305 | ˜380-420 | 85.4 |
| V4 in DMSO/EG^{b} | | | |

^{a}The compounds are in aqueous dispersion with any additional solvents listed.
^{b}H. C. Starck GmbH; Goslar, DE
^{c}The sheet resistance range of 620-680 is for portions of the film with visible light transmission values above 85%; and the sheet resistance range in parentheses represents the range of sheet resistance values observed for film portions with visible light transmission values below 85%.
^{d}The visible light transmission levels are uncorrected for substrate. Corrected values would be >90%.

TABLE 2
Physical Characteristics of Example
Conductive Polymers Containing SWNT's

| | | | Sheet | Calculated | Visible Light |
|---|---|---|---|---|---|
| | | | Resistance | Conductivity | Transmission^{c} |
| Ex. | Modified Polymer | Nano-particle | (Ω/□) | (S/cm) | (%) |
| 1 | Baytron F HC | SWNT | 585-615 | ˜300-500 | 86.3 |
| | | | (450-495)^{b} | | (84.6)^{b} |
| 2 | Baytron P HC V4 | SWNT | 180-190 | ˜580-620 | 84.9 |
| 3 | Baytron P HC V4-Au | SWNT | 170-190 | ˜590-640 | 84.9 |
| 4 | Baytron P HC V4-Ag | SWNT | 210-220 | ˜590-610 | 86.5 |
| 5 | Baytron P HC V4-Ag | SWNT | 190-210 | ˜600-640 | 85.8 |

^{a}Typical SWNT bundle size was 5-50 nm (as measured by TEM).
^{b}The sheet resistance value ranges in parentheses is for portions of the film with visible light transmission values below 85%; and the sheet resistance range in parentheses represents the range of sheet resistance values observed for film portions with visible light transmission values above 85%.
^{c}The visible light transmission levels are uncorrected for substrate. Corrected values would be >90%.

### Example 2

### Synthesis of Baytron P HC V4/SWNT-Nanoparticle Composition

1.0 mg of carboxyl acid-functionalized SWNT's (Carbon Nanotechnology, Inc.; Houston, Tex.) were mixed with 40.0 g of distilled water and 0.15 g of PSS. The mixture was sonicated until a uniform SWNT suspension was formed (60-120 minutes). The SWNT's were purified, prior to forming the mixture above, as described above.

48.03 g of Baytron P HC V4 (formulated PEDOT/PSS in an aqueous dispersion), 2.42 g of dimethyl sulfone (DMSO), and 1.48 g of ethylene glycol (EG) were combined at ambient temperature, with stirring, in a 250 ml three-necked round-bottom flask equipped with a condenser and a thermometer. The mixture was stirred for at least 30 minutes at room temperature.

1.08 g of the SWNT suspension was added to 15.28 g of the Baytron P HC V4 mixture and sonicated for 30 minutes. The resulting mixture was a hybrid conductive polymer comprised of Baytron P HC V4 with dispersed SWNT/PSS.

Transmission electron microscopy measurements indicated that SWNT's were well dispersed in the Baytron P HC V4 polymer (data not shown) with a typical SWNT size ranging from 5 nm to 30 nm.

The sheet resistance of the conductive polymer (Baytron P HC V4) modified with the same DMSO/EG was about 280-305 Ohms/sq. at the visible light transmission of 85.4%. The calculated electrical conductivity of modified Baytron P HC V4 was about 380-420 S/cm. However, the sheet resistance of the newly designed hybrid conductive polymer composite (Baytron P HC V4-SWNT/PSS) was improved to 180-190 Ohms./sq. at the visible light transmission of 84.9%. The calculated electrical conductivity of hybrid Baytron P HC V4-SWNT/PSS was improved to at least about 580-620 S/cm.

Table 2 above contains the physical property measurement results for this hybrid polymer. As can readily be seen from a comparison of the sheet resistance, calculated electrical conductivity, and visible light transmission of the synthesized polymer composite (Table 2) to the values for the polymer precursor (Table 1), both the sheet resistance and calculated electrical conductivity were improved and the visible light transmission was not greatly affected.

### Example 3

### Synthesis of Baytron P HC V4-Au/SWNT-Nanoparticle Composition

2.0 mg of carboxyl acid-functionalized SWNT's (Carbon Nanotechnology, Inc.; Houston, Tex.) were mixed with 40.0 g of distilled water and 1 g of PSS. The mixture was sonicated until a uniform SWNT suspension was formed (60-240 minutes). The SWNT's were purified, prior to forming the mixture above, as described above.

Baytron P HC V4-Au was formed by first combining 30.0 g of Baytron P HC V4 (formulated PEDOT/PSS in an aqueous dispersion) (H.C. Starck, GmbH.; Goslar, Del.), 1.5 g of dimethyl sulfone (DMSO) and 0.5 g of ethylene glycol (EG) at ambient temperature, with stirring, in a 250 ml three-necked round-bottom flask equipped with a condenser and a thermometer. The mixture was stirred for at least 30 minutes at ambient temperature. 3.8 mg of HAuCl₄ in 2.0 g of distilled water was rapidly added to the flask at ambient temperature. The mixture was vigorously stirred for an additional 30 minutes. 2.1 mg of NaBH₄ was dissolved into 2.5 g of ice cold (0°-5° C.) distilled water. The cold NaBH₄ solution was added to the flask, and the mixture was vigorously stirred for an additional 60 minutes. The resulting mixture was a dispersion of Baytron P HC V4 with attached Au nanoparticles.

Transmission electron microscopy measurements indicated that Au nanoparticles were directly formed in the Baytron P HC V4 polymer dispersion, and their size was controlled within 5 nm to 15 nm with generally spherical shape. The sheet resistance was about 190 to about 200 Ohms/sq., the calculated electrical conductivity was about 565 to about 575 S/cm, and the visible light transmission level was 84.9% for the Baytron P HC V4-Au composition.

To form the Baytron P HC V4-Au/SWNT-nanoparticle composition, 10.62 g of the Baytron P HC V4-Au dispersion (containing dimethyl sulfone (DMSO) and ethylene glycol (EG)) was added to a 50 ml round-bottom flask. 0.60 g of the SWNT suspension was added to the Baytron P HC V4-Au mixture and sonicated for 15-60 minutes and then stirred for 15-60 minutes. The resulting mixture consisted of Baytron P HC V4-Au with dispersed SWNT/PSS.

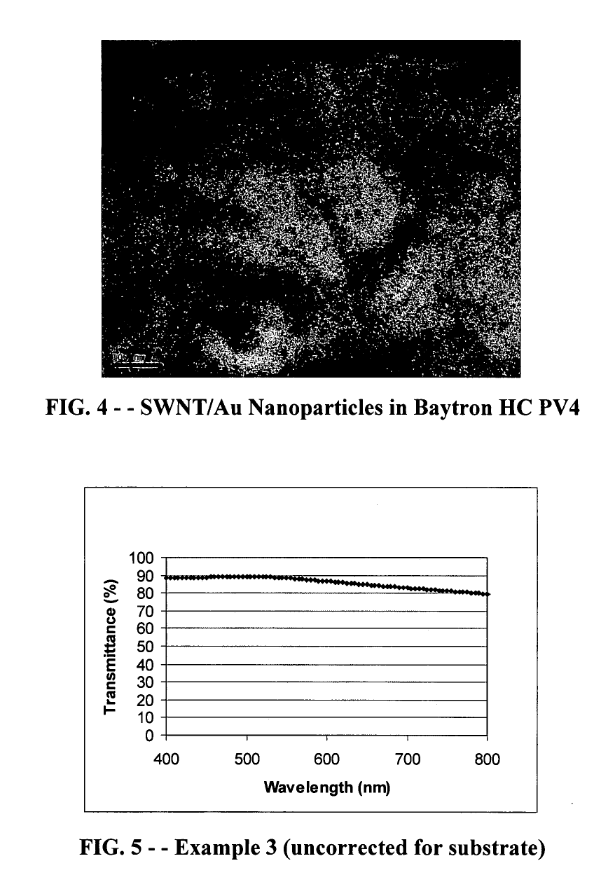

Transmission electron microscopy measurements indicated that SWNT's were well dispersed within the Baytron F HC polymer. FIG. 4 is a TEM image of a film made from this example's composition, which shows the Au nanoparticles dispersed throughout the composition and the SWNT's forming elongated tubular shapes of 5 nm to 40 nm within the polymer matrix.

FIG. 5 is a UV/Vis transmission spectrum for a thin film made with this polymer, which shows that the visible light transmission level is consistently high (greater than about 80%; greater than about 90% when corrected for substrate) for the polymer of this example.

The sheet resistance of the conductive polymer (Baytron P HC V4) modified with the same DMSO/EG was about 280-305 Ohms/sq. at the visible light transmission of 85.4%. The calculated electrical conductivity of modified Baytron P HC V4 was about 380-420 S/cm. The sheet resistance of the newly designed hybrid conductive polymer composite (Baytron P HC V4-Au NP) was improved to 190-200 Ohms/sq. at the visible light transmission of 84.9%. The calculated electrical conductivity of hybrid Baytron P HC V4-Au NP was improved to at least about 565-575 S/cm. Furthermore, the sheet resistance of the newly designed hybrid conductive polymer composite (Baytron P HC V4-Au NP-SWNT/PSS) was further improved to 170-190 Ohms/sq. at the visible light transmission of 84.9%. The calculated electrical conductivity of hybrid Baytron P HC V4-Au NP-SWNT/PSS was further improved to about 590-640 S/cm.

Table 2 above contains the physical property measurement results for this hybrid polymer composite. As can readily be seen from a comparison of the sheet resistance, calculated electrical conductivity, and visible light transmission of the synthesized polymer composite (Table 2) to the values for the unmodified polymer precursor (Table 1), both the sheet resistance and calculated electrical conductivity were improved and the visible light transmission was not greatly impacted.

### Example 4

### Synthesis of Baytron P HC V4-Ag/SWNT-Nanoparticle Composition

1.0 mg of carboxyl acid-functionalized SWNT's (Carbon Nanotechnology, Inc.; Houston, Tex.) were mixed with 40.0 g of distilled water and 0.1 g of PSS. The mixture was sonicated until a uniform SWNT suspension was formed (60-240 minutes). The SWNT's were purified, prior to forming the mixture above, as described above.

Bayton P HC V4-Ag was formed by first combining 43.0 g of Baytron P HC V4 (formulated PEDOT/PSS in an aqueous dispersion), 2.51 9 of dimethyl sulfone (DMSO) and 0.92 g of ethylene glycol (EG) with stirring in a 250 ml three-necked round-bottom flask equipped with a condenser and a thermometer. The mixture was stirred for at least 30 minutes at room temperature. 3.4 mg of AgNO₃ in 2.5 g distilled water was rapidly added to the flask and the mixture was vigorously stirred for 30 minutes. 2.4 mg of NaBH₄ was dissolved into 2.5 g of cold distilled water. The NaBH₄ solution was added to the flask and the mixture was vigorously stirred for an additional 60 minutes. The resulting mixture was a dispersion of Baytron P HC V4 with attached Ag nanoparticles.

Transmission electron microscopy measurements indicated that Ag nanoparticles were directly formed in the Baytron P HC V4 polymer dispersion and their size was controlled within 10 nm to 20 nm with generally spherical shape. The sheet resistance was about 180 to about 190 Ohms/sq., the calculated electrical conductivity was about 670 to about 680 S/cm, and the visible light transmission level was 85.1% for the Baytron P HC V4-Ag composition.

To form the Baytron P HC V4-Ag/SWNT-nanoparticle composition, 10.40 g of the Baytron P HC V4-Ag dispersion (containing dimethyl sulfone (DMSO) and ethylene glycol (EG)) was added to a 50 ml round-bottom flask. 0.60 g of the SWNT suspension was added to the Baytron P HC V4-Ag mixture and sonicated for 30 [15-60] minutes and then stirred for 30 [15-60] minutes. The resulting mixture consisted of Baytron P HC V4-Ag with dispersed SWNT/PSS.

The sheet resistance of the conductive polymer (Baytron P HC V4) modified with the same DMSO/EG was about 350-360 Ohms/sq. at the visible light transmission of 86.5%. The calculated electrical conductivity of modified Baytron P HC V4 was about 370-390 S/cm. The sheet resistance of the newly designed hybrid conductive polymer composite (Baytron P HC V4-Ag NP) was improved to 230-240 Ohms/sq. at the visible light transmission of 86.6%. The calculated electrical conductivity of hybrid Baytron P HC V4-Ag NP was improved to at least about 550-580 S/cm. Furthermore, the sheet resistance of the newly designed hybrid conductive polymer composite (Baytron P HC V4-Ag NP-SWNT/PSS) was further improved to 210-220 Ohms/sq. at the visible light transmission of 86.5%. The calculated electrical conductivity of hybrid Baytron P HC V4-Ag NP-SWNT/PSS was further improved to about 590-610 S/cm.

Table 2 above contains the physical property measurement results for this hybrid polymer composite. As can readily be seen from a comparison of the sheet resistance, calculated electrical conductivity, and visible light transmission of the synthesized polymer composite (Table 2) to the values for the polymer precursor (Table 1), both the sheet resistance and calculated electrical conductivity were improved and the visible light transmission was not greatly impacted.

### Example 5

### Synthesis of Baytron P HC V4-Ag/SWNT-Nanoparticle Composition

1.0 mg of carboxyl acid-functionalized SWNT's (Carbon Nanotechnology, Inc.; Houston, Tex.) were mixed with 40.0 g of distilled water and 0.1 g of PSS. The mixture was sonicated until a uniform SWNT suspension was formed (60-240 minutes). The SWNT's were purified, prior to forming the mixture above, as described above.

11.50 g of the Baytron P HC V4-Ag dispersion formed in Example 4 (containing dimethyl sulfone (DMSO) and ethylene glycol (EG)) was added to a 50 ml round-bottom flask. 0.70 g of the SWNT suspension was added to the Baytron P HC V4-Ag mixture and sonicated for 30 (range 15-60) minutes and then stirred for 30 (15-60) minutes. The resulting mixture consisted of Baytron P HC V4-Ag with dispersed SWNT/PSS.

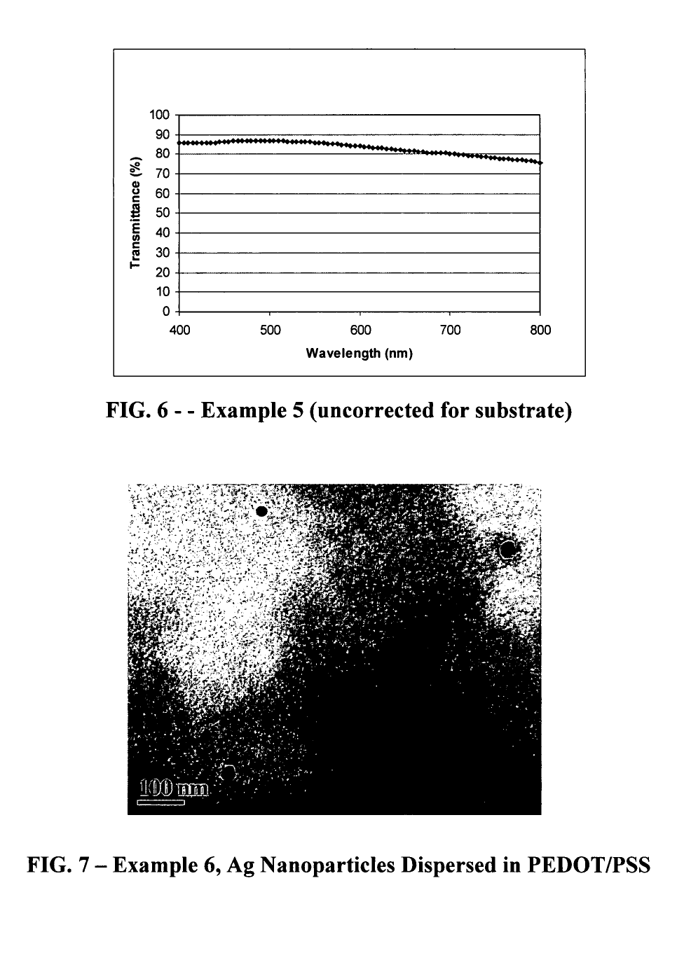

FIG. 6 is a UV/Vis transmission spectrum for a thin film made with this polymer composite, which shows that the visible light transmission level is consistently high (greater than about 80%; greater than about 90% when corrected for substrate) for the polymer of this example.

The sheet resistance of the conductive polymer (Baytron P HC V4) modified with the same DMSO/EG was about 280-305 Ohms/sq. at the visible light transmission of 85.4%. The calculated electrical conductivity of modified Baytron P HC V4 was about 380-420 S/cm. However, the sheet resistance of the newly designed hybrid conductive polymer composite (Baytron P HC V4-Ag NP) was improved to 180-190 Ohms/sq. at the visible light transmission of 85.1%. The calculated electrical conductivity of hybrid Baytron P HC V4-Ag NP was improved to at least about 585-620 S/cm. Furthermore, the sheet resistance of the newly designed hybrid conductive polymer composite (Baytron P HC V4-Ag NP-SWNT/PSS) was further improved to 190-210 Ohms/sq. at the visible light transmission of 85.8%. The calculated electrical conductivity of hybrid Baytron P HC V4-Ag NP-SWNT/PSS was further improved to about 600-640 S/cm.

Table 2 above contains the physical property measurement results for this hybrid polymer composite. As can readily be seen from a comparison of the sheet resistance, calculated electrical conductivity, and visible light transmission of the synthesized polymer composite (Table 2) to the values for the polymer precursor (Table 1), both the sheet resistance and calculated electrical conductivity were improved and the visible light transmission was not greatly impacted. As compared to Example 4, this example illustrates that different loading levels of SWNT's can impact the sheet resistance and calculated electrical conductivity.

### Examples 6-14

### PEDOT/PSS/Metallic Nanoparticles

The following examples relate to conductive polymer compositions comprising metallic nanoparticles.

### Example 6

### Synthesis of Baytron F HC/Ag-Nanoparticle Composition

39.15 g of Baytron F HC (formulated PEDOT/PSS in an aqueous dispersion) (H.C. Starck, GmbH.; Goslar, Del.), 2.05 g of dimethyl sulfone (DMSO) and 0.75 g of ethylene glycol (EG) were combined with stirring in a 250 ml three-necked round-bottom flask equipped with a condenser and a thermometer. The mixture was stirred for at least 30 minutes at room temperature. 4.1 mg of AgNO₃ (dispersed in 2.2 g distilled water) was added to the flask and the mixture was vigorously stirred for 30 minutes. 3.1 mg of NaBH₄ was dissolved into 2.3 g of cold distilled water. The NaBH₄ solution was added to the flask and the mixture was vigorously stirred for an additional 60 minutes. The resulting mixture was a dispersion of Baytron F HC with attached Ag-nanoparticles.

Transmission electron microscopy measurements indicated that Ag-nanoparticles were directly formed in the Baytron F HC polymer dispersion with a size ranging from 5 nm to 30 nm. FIG. 7 is a TEM image of a film made from the composition of this example, which confirms Ag-nanoparticle size to be controlled within 5 nm to 30 nm with generally spherical shape.

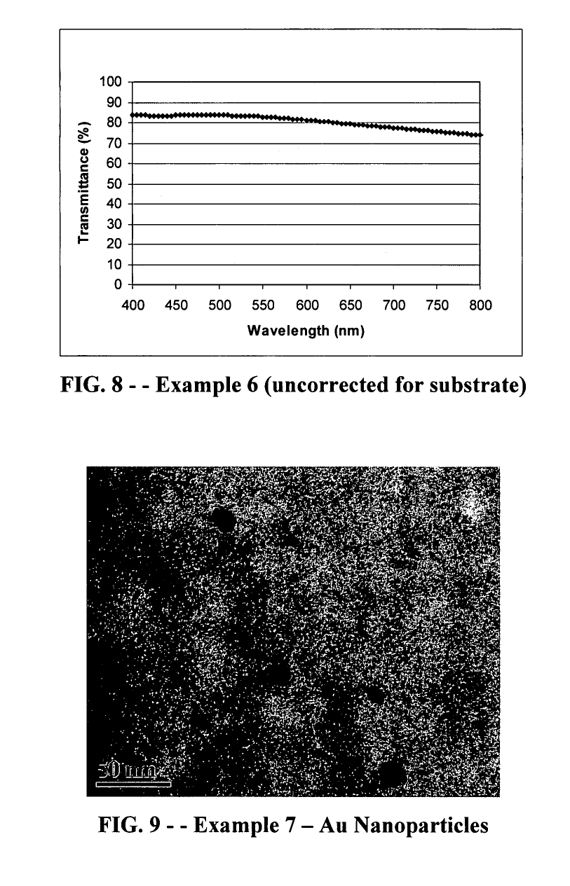

FIG. 8 is a UV/Vis transmission spectrum for a thin film made with this polymer, which shows that the visible light transmission level is consistently high (greater than about 80%; greater than about 90% when corrected for substrate) for this. polymer.

The sheet resistance of the conductive polymer dispersion (Baytron F HC) modified with the same DMSO/EG was about 620-680 Ohms/sq. (or 595-635 Ohms/sq.) at the visible light transmission of 85.3% (or 84.7%). The estimated electrical conductivity of modified Baytron F HC was about 210-230 S/cm. However, the sheet resistance of the newly designed hybrid conductive polymer dispersion (Baytron F HC-Ag NP) was improved to 450-490 Ohms/sq. (or 390-450 Ohms/sq.) at the visible light transmission of 85.3% (or 84.6%). The calculated electrical conductivity of hybrid Baytron F HC-Ag NP was improved to at least about 300-340 S/cm.

Table 4 below contains the physical property measurement results for a film made with this polymer. As can readily be seen from a comparison of the sheet resistance, calculated electrical conductivity, and visible light transmission of the synthesized polymer(s) (Table 4) to the values for the PEDOT/PSS polymer precursors (Table 3), both the sheet resistance and calculated electrical conductivity were improved and the visible light transmission did not decrease.

TABLE 3
Reference/Comparison Examples of Unmodified Conductive Polymers

| | Sheet Resistance | Conductivity | Visible Light |
|---|---|---|---|
| Compound^{a} | (Ω/□) | (S/cm) | Transmission (%)^{e} |
| Baytron F HC | 620-680 (585-635)^{c} | ˜210-230 | 85.3 (84.7)^{c} |
| in DMSO/EG^{b} | | | |
| Baytron P HC | 280-305 | ˜380-420 | 85.4 |
| V4 in | | | |
| DMSO/EG^{b} | | | |
| Baytron PH | 210-235 | ˜480-520 | 85.3 |
| 500 in | | | |
| DMSO/EG^{b} | | | |
| Agfa New | 585-625 | ˜250-260 | 87.6 |
| Spin^{d} | | | |

^{a}The compounds were coated from an aqueous dispersion with any additional solvents listed.
^{b}H. C. Starck GmbH; Goslar, D
^{c}The sheet resistance range of 620-680 is for portions of the film with visible light transmission values above 85%; and the sheet resistance range in parentheses represents the range of sheet resistance values observed for film portions with visible light transmission values below 85%.
^{d}Agfa-Gevaert NV; Mortsel, Belgium.
^{e}The visible light transmission levels are uncorrected for substrate. Corrected values would be >90%.

TABLE 4
Physical Characteristics of Example Conductive Polymers
Containing Metallic NanoParticles

| | | | | Nano- | | | |
|---|---|---|---|---|---|---|---|
| | | Nano- | | particle | Sheet | Calculated | Visible Light |
| | Modified | particle | Nano- | size | Resistance | Conductivity | Transmission^{d} |
| Ex. | Polymer | Precursor | particle | (nm)^{a} | (Ω/□) | (S/cm) | (%) |
| 6 | Baytron F HC | AgNO₃ | Ag | 5-30 | 450-490 | ˜300-340 | 85.3 |
| 7 | Baytron F HC | HAuCl₄ | Au | 10-20 | 440-465 | ˜310-330 | 85.3 |
| | | | | | (380-405)^{b} | | (84.3)^{b} |
| 8 | Baytron F HC | Na₂PtCl₄ | Pt | 3-10 | 475-500 | ˜300 | 84.7 |
| 9 | Baytron P HC V4 | HAuCl₄ | Au | 5-15 | 190-200 | ˜565-575 | 84.9 |
| 10 | Baytron P HC V4 | AgNO₃ | Ag | 10-20 | 180-190 | ˜585-620 | 85.1 |
| 11 | Baytron PH 500 | AgNO₃ | Ag | 5-25 | 180-195 | ˜570-630 | 85.2 |
| 12 | Baytron PH 500 | HAuCl₄ | Au | 5-10 | 195-200 | ˜670-680 | 85.5 |
| 12^{c} | Baytron PH 500 | HAuCl₄ | Au | 5-10 | [50-60] | ˜730-750 | 70 |
| 13 | Agfa New Spin | AgNO₃ | Ag | 10-40 | 430-440 | ˜350-360 | 87.6 |
| 14 | Agfa New Spin | HAuCl₄ | Au | 6-10 | 380-400 | ˜360-380 | 87.0 |

^{a}As measured by TEM.
^{b}The values not in parentheses, i.e., 440-465 and 85.3%, are for portions of the film with visible light transmission values below 85%; and the sheet resistance range in parentheses represents values above 85%.
^{c}The film of Example 12B had an increased thickness compared to the 12A film.
^{d}The visible light transmission levels are uncorrected for substrate. Corrected values would be >90%.

### Example 7

### Synthesis of Baytron F HC/Au-Nanoparticle Composition

40.21 g of Baytron F HC (formulated PEDOT/PSS in an aqueous dispersion), 2.02 g of dimethyl sulfone (DMSO) and 0.85 g of ethylene glycol (EG) were combined with stirring in a 250 ml three-necked round-bottom flask equipped with a condenser and a thermometer. The mixture was stirred for at least 30 minutes at room temperature. 6.1 mg of HAuCl₄ in 1.6 g of distilled water was rapidly added to the flask at ambient temperature. The mixture was vigorously stirred for an additional 30 minutes. 2.7 mg of NaBH₄ was dissolved into 2.0 g of cold distilled water. The cold NaBH₄ solution was then added to the flask, and the mixture was vigorously stirred for an additional 90 minutes. The resulting mixture was a dispersion of Baytron F HC with attached Au-nanoparticles.

Transmission electron microscopy measurements indicated that Au-nanoparticles were directly formed in the Baytron F HC polymer dispersion with a size ranging from 10 nm to 20 nm. FIG. 9 is a TEM image of a film made from the polymer composition of this example, which confirms Au nanoparticle size to be controlled within 10 nm to 20 nm with generally spherical shape.

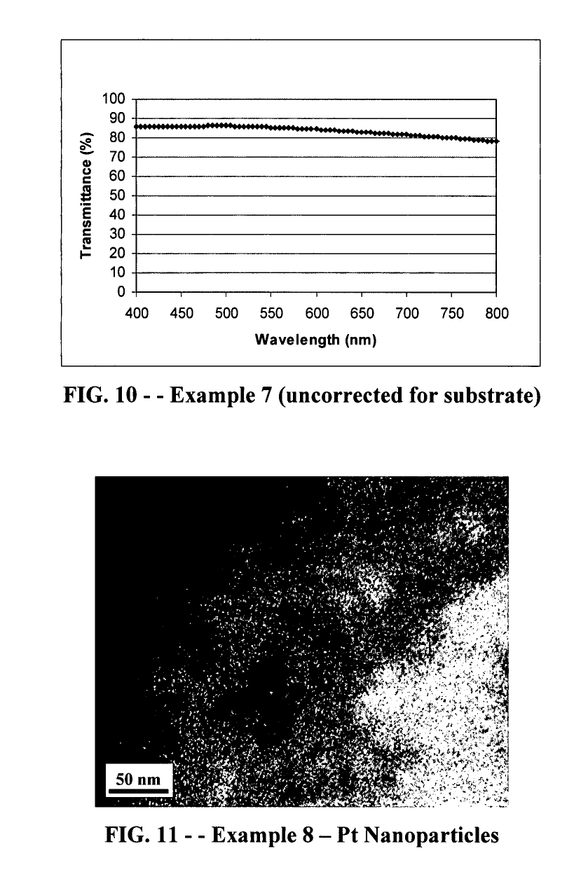

FIG. 10 is a UV/Vis transmission spectrum for a thin film made with this polymer composition, which shows that the visible light transmission level is consistently high (greater than about 80%; greater than about 90% when corrected for substrate) for this polymer.

The sheet resistance of the conductive polymer dispersion (Baytron F HC) modified with the same DMSO/EG was about 620-680 Ohms/sq. (or 595-635 Ohms/sq.) at the visible light transmission of 85. 3% (or 84.7%). The estimated electrical conductivity of modified Baytron F HC was about 210-230 S/cm. However, the sheet resistance of the newly designed hybrid conductive polymer dispersion (Baytron F HC-Au NP) was improved to 440-465 Ohms/sq. (or 380-405 Ohms/sq.) at the visible light transmission of 85.3% (or 84.3%). The calculated electrical conductivity of hybrid Baytron F HC-Au NP was improved to at least 310-330 S/cm.

Table 4 above contains the physical property measurement results for a film made with the polymer formed in this example. Two sheet resistance and visible light transmission values are provided. The first sheet resistance value of 440-465 Ohms/sq. related to portions of the film with visible light transmission values below 85%, and the value in parentheses related to portions of the film with visible light transmission values above 85%. As can readily be seen from a comparison of the sheet resistance, calculated electrical conductivity, and visible light transmission of the synthesized polymers (Table 4) to the values for the unmodified polymer precursors (Table 3), both the sheet resistance and calculated electrical conductivity were improved, and the visible light transmission was not greatly impacted.

### Example 8

### Synthesis of Baytron F HC/Pt-Nanoparticle Composition

42.75 g of Baytron F HC (formulated PEDOT/PSS in an aqueous dispersion), 3.08 g of dimethyl sulfone (DMSO) and 0.85 g of ethylene glycol (EG) were combined with stirring at ambient temperature in a 250 ml three-necked round-bottom flask equipped with a condenser and a thermometer. The mixture was stirred for at least 30 minutes at ambient temperature. 3.2 mg of Na₂PtCl₄ in 2.5 g of distilled water was rapidly added to the flask, also at ambient temperature. The mixture was vigorously stirred for an additional 30 minutes. 3.4 mg of NaBH₄ was dissolved into 2.5 g of cold distilled water. The cold NaBH₄ cold solution was added to the flask, and the mixture was vigorously stirred for an additional 90 minutes. The resulting mixture was a dispersion of Baytron F HC with attached Pt-nanoparticles.

Transmission electron microscopy measurements indicated that Pt-nanoparticles were directly formed in the Baytron F HC polymer dispersion with a size ranging from 3 nm to 10 nm. FIG. 11 is a TEM image of a film made from the polymer composition formed in this example, which confirms Pt nanoparticle size to be controlled within 3 nm to 10 nm with generally spherical shape.

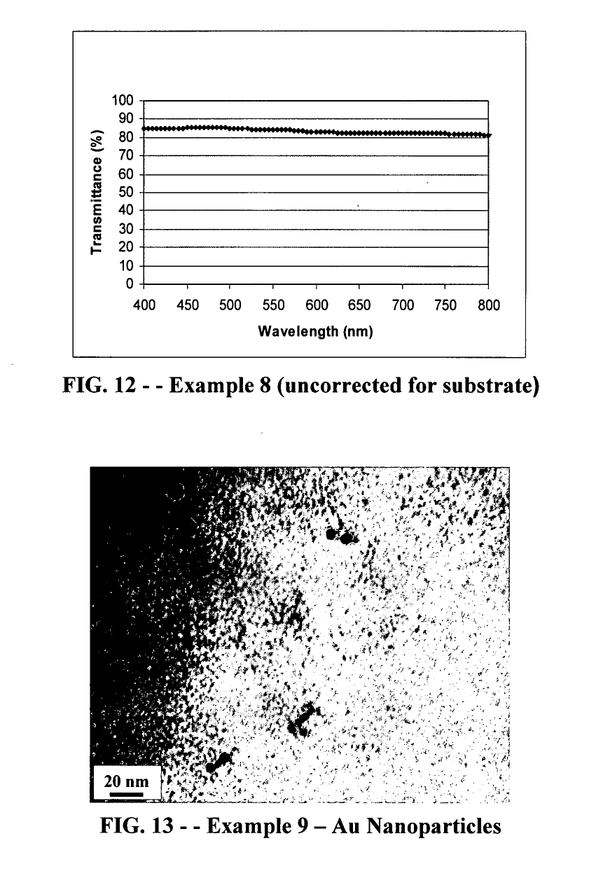

FIG. 12 is a UV/Vis transmission spectrum for a thin film made with this polymer, which shows that the visible light transmission level is consistently high (greater than about 80%; greater than about 90% when corrected for substrate) for the polymer composition of this example.

The sheet resistance of the conductive polymer dispersion (Baytron F HC) modified with the same amount of DMSO/EG was about 620-680 Ohms/sq. (or 595-635 Ohms/sq.) at the visible light transmission of 85.3% (or 84.7%). The estimated electrical conductivity of modified Baytron F HC was about 210-230 S/cm. However, the sheet resistance of the newly designed hybrid conductive polymer composite (Baytron F HC-Pt NP) was improved to 475-500 Ohms/sq. at the visible light transmission of 84.7%. The calculated electrical conductivity of hybrid Baytron F HC-Pt was improved to at least about 300 S/cm.

Table 4 above contains the physical property measurement results for a film made with this polymer. As can readily be seen from a comparison of the sheet resistance, calculated electrical conductivity, and visible light transmission of the synthesized polymer (Table 4) to the values for the unmodified polymer precursor (Table 3), both the sheet resistance and calculated electrical conductivity were improved and the visible light transmission was not greatly impacted.

### Example 9

### Synthesis of Baytron P HC V4/Au Nanoparticle Composition

30.0 g of Baytron P HC V4 (formulated PEDOT/PSS in an aqueous dispersion) (H.C. Starck, GmbH.; Goslar, Del.), 1.5 g of dimethyl sulfone (DMSO) and 0.5 g of ethylene glycol (EG) were combined at ambient temperature, with stirring, in a 250 ml three-necked round-bottom flask equipped with a condenser and a thermometer. The mixture was stirred for at least 30 minutes at ambient temperature. 3.8 mg of HAuCl₄ in 2.0 g of distilled water was rapidly added to the flask, also at ambient temperature. The mixture was vigorously stirred for an additional 30 minutes. 3.1 mg of NaBH₄ was dissolved into 2.5 g of cold distilled water. The cold NaBH₄ solution was added to the flask, and the mixture was vigorously stirred for an additional 60 minutes. The resulting mixture was a dispersion of Baytron P HC V4 with attached Au nanoparticles.

Transmission electron microscopy measurements indicated that Au nanoparticles were directly formed in the Baytron P HC V4 polymer dispersion having a particle size ranging from 5 nm to 15 nm. FIG. 13 is a TEM image of a film made from the polymer composition of this example, which confirms Au nanoparticle size to be controlled within 5 nm to 15 nm with generally spherical shape.

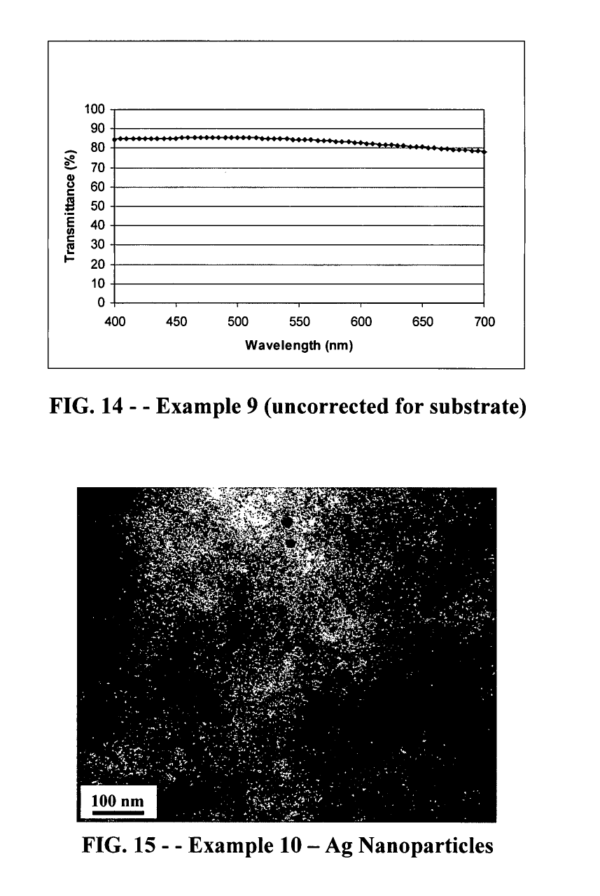

FIG. 14 is a UV/Vis transmission spectrum for a thin film made from the polymer composition of this example, which shows that visible light transmission level is consistently high (greater than about 80%; greater than about 90% when corrected for substrate) for this polymer.

The sheet resistance of the conductive polymer (Baytron P HC V4) modified with the same DMSO/EG was about 280-305 Ohms/sq. at the visible light transmission of 85.4%. The calculated electrical conductivity of modified Baytron P HC V4 was about 380-420 S/cm. However, the sheet resistance of the newly designed hybrid conductive polymer composite (Baytron P HC V4-Au NP) was improved to 190-200 Ohms/sq. at the visible light transmission of 84.9%. The calculated electrical conductivity of hybrid Baytron P HC V4-Au NP was improved to at least about 565-575 S/cm.

Table 4 above contains the physical property measurement results for this polymer. As can readily be seen from a comparison of the sheet resistance, calculated electrical conductivity, and visible light transmission of the synthesized polymers (Table 4) to the values for the unmodified polymer precursors (Table 3), both the sheet resistance and calculated electrical conductivity were improved and the visible light transmission was not greatly impacted.

### Example 10

### Synthesis of Baytron P HC V4/Ag-Nanoparticle Composition

43.0 g of Baytron P HC V4 (formulated PEDOT/PSS in an aqueous dispersion), 2.51 g of dimethyl sulfone (DMSO) and 0.92 g of ethylene glycol (EG) were combined at ambient temperature, with stirring, in a 250 ml three-necked round-bottom flask equipped with a condenser and a thermometer. The mixture was stirred for at least 30 minutes at ambient temperature. 3.4 mg of AgNO₃ in 2.5 g distilled water was rapidly added to the flask, and the mixture was vigorously stirred for an additional 30 minutes. 2.4 mg of NaBH₄ was dissolved into 2.5 g of ice cold distilled water. The cold NaBH₄ solution was added to the flask, and the mixture was vigorously stirred for an additional 60 minutes. The resulting mixture was a dispersion of Baytron P HC V4 with attached Ag-nanoparticles.

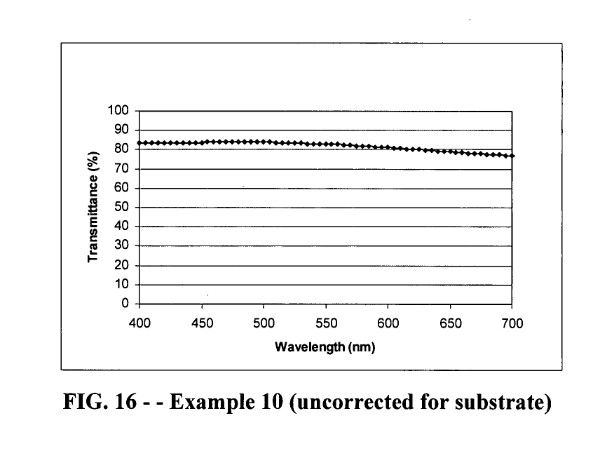

Transmission electron microscopy measurements indicated that Ag nanoparticles were directly formed in the Baytron P HC V4 polymer dispersion having a particle size from 10 nm to 20 nm. FIG. 15 is a TEM image of a film made from the polymer composition of this example, which confirms Ag nanoparticle size to be controlled within 10 nm to 20 nm with generally spherical shape.

FIG. 16 is a UV/Vis transmission spectrum for a thin film made with the polymer composition of this example, which shows that the visible light transmission level is consistently high (greater than about 80%; greater than about 90% when corrected for substrate) for this polymer.

The sheet resistance of the conductive polymer (Baytron P HC V4) modified with the same DMSO/EG was about 280-305 Ohms/sq. at the visible light transmission of 85.4%. The calculated electrical conductivity of modified Baytron P HC V4 was about 380-420 S/cm. However, the sheet resistance of the newly designed hybrid conductive polymer composite (Baytron P HC V4-Ag NP) was improved to 180-190 Ohms/sq. at the visible light transmission of 85.1%. The calculated electrical conductivity of hybrid Baytron P HC V4-Ag NP was improved to at least about 585-620 S/cm.

Table 4 above contains the physical property measurement results for this polymer. As can readily be seen from a comparison of the sheet resistance, calculated electrical conductivity, and visible light transmission of the synthesized polymers (Table 4) to the values for the unmodified polymer precursors (Table 3), both the sheet resistance and calculated electrical conductivity were improved and the visible light transmission did not decrease.

### Example 11

### Synthesis of Baytron PH 500/Ag-Nanoparticle Composition

19.85 g of Baytron PH 500 (formulated PEDOT/PSS in an aqueous dispersion) (H.C. Starck, GmbH.; Goslar, Del.), 0.80 g of dimethyl sulfone (DMSO) and 0.45 9 of ethylene glycol (EG) were combined at ambient temperature, with stirring, in a 250 ml three-necked round-bottom flask equipped with a condenser and a thermometer. The mixture was stirred for at least 20 minutes at ambient temperature. 2.0 mg of AgNO₃ in 1.65 g distilled water was rapidly added to the flask, and the mixture was vigorously stirred for an additional 30 minutes. 2.0 mg of NaBH₄ was dissolved into 2.9 g of ice cold distilled water. The cold NaBH₄ solution was added to the flask, and the mixture was vigorously stirred for an additional 45 minutes. The resulting mixture was a dispersion of Baytron PH 500 with attached Ag-nanoparticles.

Transmission electron microscopy measurements indicated that Ag-nanoparticles were directly formed in the Baytron PH 500 polymer dispersion (data not shown) having a particle size ranging from 5 nm to 25 nm.

The sheet resistance of the conductive polymer (Baytron PH 500) modified with the same DMSO/EG was about 210-235 Ohms/sq. at the visible light transmission of 85.3%. The calculated electrical conductivity of modified Baytron PH 500 was about 480-520 S/cm. However, the sheet resistance of the newly designed hybrid conductive polymer composite (Baytron PH 500-Ag NP) was improved to 180-195 Ohms/sq. at the visible light transmission of 85.2%. The calculated electrical conductivity of hybrid Baytron PH 500-Ag NP was improved to at least about 570-630 S/cm.

Table 4 above contains the physical property measurement results for this polymer. As can readily be seen from a comparison of the sheet resistance, calculated electrical conductivity, and visible light transmission of the synthesized polymers (Table 4) to the values for the unmodified polymer precursors (Table 3), both the sheet resistance and calculated electrical conductivity were improved and the visible light transmission did not decrease.

### Example 12

### Synthesis of Baytron PH 500/Au-Nanoparticle Composition

20.9 g of Baytron PH 500 (formulated PEDOT/PSS in an aqueous dispersion), 1.0 g of dimethyl sulfone (DMSO) and 0.47 g of ethylene glycol (EG) were combined at ambient temperature, with stirring, in a 250 ml three-necked round-bottom flask equipped with a condenser and a thermometer. The mixture was stirred for at least 20 minutes at ambient temperature. 2.4 mg of HAuCl₄ in 1.7 g of distilled water was rapidly added to the flask at ambient temperature. The mixture was vigorously stirred for an additional 30 minutes. 1.7 mg of NaBH₄ was dissolved into 1.7 g of ice cold distilled water. The cold NaBH₄ solution was added to the flask, and the mixture was vigorously stirred for an additional 45 minutes. The resulting mixture was a dispersion of Baytron PH 500 with attached Au-nanoparticles.

Transmission electron microscopy measurements indicated that Au-nanoparticles were directly formed in the Baytron PH 500 polymer dispersion (data not shown) having a particle size ranging from 5 nm to 10 nm.

The sheet resistance of the conductive polymer (Baytron PH 500) modified with the same DMSO/EG was about 210-235 Ohms/sq. at the visible light transmission of 85.3%. The calculated electrical conductivity of modified Baytron PH 500 was about 480-520 S/cm. However, the sheet resistance of the newly designed hybrid conductive polymer composite (Baytron PH 500-Au NP) was improved to 175-180 Ohms/sq. at the visible light transmission of 84.6%. The calculated electrical conductivity of hybrid Baytron PH 500-Au NP was improved to at least about 680-705 S/cm. Furthermore, the sheet resistance of the newly designed hybrid conductive polymer composite (Baytron PH 500-Au NP) was improved to 195-200 Ohms/sq. at the visible light transmission of 85.5%. The calculated electrical conductivity of hybrid Baytron PH 500-Au NP was improved to at least about 670-680 S/cm. As an increase in thickness, the visible light transmission of 70%, the sheet resistance of the newly designed hybrid conductive polymer composite (Baytron PH 500-Au NP) was improved to 50-60 Ohms/sq. Then, the calculated electrical conductivity of hybrid Baytron PH 500-Au NP was improved to at least about 730-750 S/cm.

Table 4 above contains the physical property measurement results for two sample thicknesses of this polymer. The first set of data (12A) is for a film of the thickness described above. The second set of data (12B) is from a film with an increased thickness. With respect to film 12A, as can readily be seen from a comparison of the sheet resistance, calculated electrical conductivity, and visible light transmission of the synthesized polymer (Table 4) to the values for the unmodified polymer precursor (Table 3), both the sheet resistance and calculated electrical conductivity were improved and the visible light transmission was not greatly impacted. The decreased sheet resistance observed for 12B, which should not be impacted by the film thickness, is possibly due to space filling at the film surface. With respect to film 12B, if the visible light transmission level can be acceptably decreased, the sheet resistance and calculated electrical conductivity of the sample can be further improved.

### Example 13

### Synthesis of Agfa New Spin/Ag-Nanoparticle Composition

29.58 g of Agfa New Spin (formulated PEDOT/PSS in an aqueous dispersion) (Agfa; Mortsel, Belgium) was added to a 250 ml three-necked round-bottom flask equipped with a condenser and a thermometer and vigorously stirred at ambient temperature. 2.2 mg of AgNO₃ in 1.6 g distilled water was rapidly added to the flask, and the mixture was vigorously stirred for an additional 30 minutes. 1.8 mg of NaBH₄ was dissolved into 2.0 g of ice cold distilled water. The cold NaBH₄ solution was added to the flask, and the mixture was vigorously stirred for an additional 60 minutes. The resulting mixture was a dispersion of Agfa New Spin with attached Ag-nanoparticles.

Transmission electron microscopy measurements indicated that Ag-nanoparticles were directly formed in the Agfa New Spin polymer dispersion (data not shown) having a particle size ranging from 10 nm to 40 nm.

The sheet resistance of the conductive polymer (Agfa New Spin) was about 585-625 Ohms/sq. at the visible light transmission of 87.6%. The calculated electrical conductivity of modified Agfa New Spin was about 250-260 S/cm. However, the sheet resistance of the newly designed hybrid conductive polymer composite (Agfa New Spin —Ag NP) was improved to 430-440 Ohms/sq. at the visible light transmission of 87.6%. The calculated electrical conductivity of hybrid (Agfa New Spin —Ag NP) was improved to at least about 350-360 S/cm.

Table 4 above contains the physical property measurement results for this polymer. As can readily be seen from a comparison of the sheet resistance, calculated electrical conductivity, and visible light transmission of the synthesized polymers (Table 4) to the values for the unmodified polymer precursors (Table 3), both the sheet resistance and calculated electrical conductivity were improved and the visible light transmission did not decrease.

### Example 14

### Synthesis of Agfa New Spin/Au-Nanoparticle Composition

30.1 g of Agfa New Spin (formulated PEDOT/PSS in an aqueous dispersion) was added to a 250 ml three-necked round-bottom flask equipped with a condenser and a thermometer and was vigorously stirred at ambient temperature. 4.5 mg of HAuCl₄ in 1.6 g of distilled water was rapidly added to the flask at ambient temperature. The mixture was vigorously stirred for 30 minutes. 1.9 mg of NaBH₄ was dissolved into 3.0 g of ice cold distilled water. The cold NaBH₄ solution was added to the flask, and the mixture was vigorously stirred for an additional 60 minutes. The resulting mixture was a dispersion of Agfa New Spin with attached Au-nanoparticles.

Transmission electron microscopy measurements indicated that Au-nanoparticles were directly formed in the Agfa New Spin polymer dispersion (data not shown) having a particle size ranging from 6 nm to 10 nm.

The sheet resistance of the conductive polymer (Agfa New Spin) was about 585-625 Ohms/sq. at the visible light transmission of 87.6%. The calculated electrical conductivity of modified Agfa New Spin was about 250-260 S/cm. However, the sheet resistance of the newly designed hybrid conductive polymer composite (Agfa New Spin —Au NP) was improved to 380-400 Ohms/sq. at the visible light transmission of 87.0%. The calculated electrical conductivity of hybrid Agfa New Spin —Au NP was improved to at least about 360-380 S/cm.

Table 4 above contains the physical property measurement results for this polymer. As can readily be seen from a comparison of the sheet resistance, calculated electrical conductivity, and visible light transmission of the synthesized polymer (Table 4) to the values for the unmodified polymer precursor (Table 3), both the sheet resistance and calculated electrical conductivity were improved and the visible light transmission was not greatly impacted.

The foregoing examples show that enhanced electrical conductivity of commercially available PEDOT/PSS formulations was achieved using the compositions and methods of the present invention. For example, the electrical conductivity of hybrid conductive thin film coatings containing Baytron F HC was enhanced up to ˜300-350 S/cm with metallic nanoparticles and SWNT/PSS, while the optical transparency remained high, as compared to ˜210-230 S/cm of DMSO modified Baytron F HC. The electrical conductivity of hybrid conductive thin film coatings containing Baytron PV4 was enhanced up to ˜640 S/cm, with metallic nano-particles, while the optical transparency remained high, as compared to ˜400 S/cm of DMSO modified Baytron PV4. The electrical conductivity of hybrid conductive thin film coatings containing Baytron PH 500 was enhanced up to ˜750 S/cm, with metallic nanoparticles, while the optical transparency remained high, as compared to ˜480-520 S/cm of DMSO modified Baytron PH 500. The electrical conductivity of hybrid conductive thin film coatings containing Agfa New Spin was enhanced up to ˜350-360 S/cm, with metallic nanoparticles, while the optical transparency remained high, as compared to ˜250-260 S/cm of NMP modified Agfa New Spin.

This written description sets forth the best mode of the invention, and describes the invention so as to enable a person skilled in the art to make and use the invention. The examples above are intended to be illustrative, but not limiting, of the claimed invention(s).

1. A conductive polymer composition comprising:
an oxidized 3,4-ethylenedioxythiopene polymer;
a polysulfonated styrene polymer; and
single wall carbon nanotubes,
the polymers and the single wall carbon nanotubes being combined such that the conductive polymer composition has a sheet resistance of less than about 200 Ohms/square, a conductivity of greater than about 300 siemens/cm, and a visible light transmission of greater than about 50% at a wavelength ranging from about 380 to 800 nm.

2. A conductive polymer composition as defined in claim 1, wherein the conductive polymer composition has a sheet resistance of less than about 175 Ohms/square.

3. A conductive polymer composition as defined in claim 1, wherein the conductive polymer composition has a sheet resistance of less than about 150 Ohms/square.

4. A conductive polymer composition as defined in claim 1, wherein the conductive polymer composition has a sheet resistance of less than about 100 Ohms/square.

5. A conductive polymer composition as defined in claim 1, wherein the conductive polymer composition has a conductivity of greater than about 450 siemens/cm.

6. A conductive polymer composition as defined in claim 1, wherein the conductive polymer composition has a conductivity of greater than about 600 siemens/cm.

7. A conductive polymer composition as defined in claim 1, wherein the conductive polymer composition has a conductivity of greater than about 750 siemens/cm.

8. A conductive polymer composition as defined in claim 1, wherein the conductive polymer composition has a conductivity of greater than about 900 siemens/cm.

9. A conductive polymer composition as defined in claim 1, wherein the conductive polymer composition has a visible light transmission level of greater than about 60%.

10. A conductive polymer composition as defined in claim 1, wherein the conductive polymer composition has a visible light transmission level of greater than about 70%.

11. A conductive polymer composition as defined in claim 1, wherein the conductive polymer composition has a visible light transmission level of greater than about 80%.

12. A conductive polymer composition as defined in claim 1, wherein the conductive polymer composition has a visible light transmission level of greater than about 90%.

13. A conductive polymer composition as defined in claim 1, wherein the single wall carbon nanotubes are free of iron.

14. A conductive polymer composition as defined in claim 1, wherein the single wall carbon nanotubes are pre-mixed with polysulfonated styrene polymer.

15. A conductive polymer composition as defined in claim 1, wherein the single wall carbon nanotubes are functionalized by molecules selected from the group consisting of carboxyl, hydroxyl, hydrogen sulfite, nitrite, amine, and mixtures thereof.

16. A conductive polymer composition as defined in claim 1, wherein the conductive polymer composition is a coating layer having an inner side and an outer side, and the inner side is bonded to a substrate.

17. A conductive polymer composition as defined in claim 16, further comprising a layer of antireflective material disposed upon the outer side of the coating layer.

18. A method for making a conductive polymer composition comprising:
a) combining a 3,4-ethylenedioxythiopene, a polysulfonated styrene, and single wall carbon nanotubes in a solvent system to form a mixture; and
b) sonicating the mixture.

19. A method for making a conductive polymer as defined in claim 18, wherein the solvent system is selected from group consisting of water, dimethylsulfone, ethylene glycol, dimethylformamide, dimethylacetamide, n-methyl pyrrolidone and mixtures thereof.

20. A method for making a conductive polymer as defined in claim 18, wherein the single wall carbon nanotubes are functionalized by molecules selected from the group consisting of carboxyl, hydroxyl, hydrogen sulfite, nitrite, amine, and mixtures thereof.

21. A method for making a conductive polymer as defined in claim 18, further comprising the step of combining the single wall carbon nanotubes and a polysulfonated styrene and sonicating this mixture separately prior to combining the single wall carbon nanotubes with the 3,4-ethylenedioxythiopene and the polysulfonated styrene.

22. A method for making a conductive polymer as defined in claim 18, wherein the single wall carbon nanotubes are free of iron.

23. A method for making a conductive polymer as defined in claim 18, further comprising purifying the single wall carbon nanotubes prior to use using the steps of:
a) heating the single wall carbon nanotubes in an oxidizing atmosphere;
b) treating the single wall carbon nanotubes with a strong acid under sonication; and
c) washing the single wall carbon nanotubes.

24. A method for making a conductive polymer as defined in claim 23, wherein the single wall carbon nanotubes are heated to a static temperature of between about 200° C. and about 500° C.

25. A method for making a conductive polymer as defined in claim 23, wherein the single wall carbon nanotubes are heated from about 200° C. to about 500° C. using a heating ramp.

26. A method for making a conductive polymer as defined in claim 23, wherein the single wall carbon nanotubes are heated in an oxidizing atmosphere for between about 0.5 hours and about 4 hours.

27. A method for making a conductive polymer as defined in claim 23, wherein the single wall carbon nanotubes are sonicated for between about 0.5 hours and about 3 hours.

28. A method for making a conductive polymer as defined in claim 23, wherein the strong acid is selected from a group consisting of H₂SO₄, HNO₃, HCl, and mixtures thereof.

29. A method for making a conductive polymer as defined in claim 23, wherein the single wall carbon nanotubes are washed with an acid solution selected from the group consisting of H₂SO₄, HNO₃, HCl, and mixtures thereof.

30. A method for making a conductive polymer as defined in claim 23, wherein the single wall carbon nanotubes are washed with solvents selected from the group consisting of water, tetrahydrofuran, isopropyl alcohol, acetone, and mixtures thereof.

31. A conductive polymer composition comprising:
an oxidized 3,4-ethylenedioxythiopene polymer;
a polysulfonated styrene polymer; and
metallic nanoparticles,
the polymers and the metallic nanoparticles being combined such that the conductive polymer composition has a sheet resistance of less than about 200 Ohms/square, a conductivity of greater than about 300 siemens/cm, and a visible light transmission of greater than about 50% at a wavelength ranging from about 380 to 800 nm.

32. A conductive polymer composition as defined in claim 31, wherein the conductive polymer composition has a sheet resistance of less than about 175 Ohms/square.

33. A conductive polymer composition as defined in claim 31, wherein the conductive polymer composition has a sheet resistance of less than about 150 Ohms/square.

34. A conductive polymer composition as defined in claim 31, wherein the conductive polymer composition has a sheet resistance of less than about 100 Ohms/square.

35. A conductive polymer composition as defined in claim 31, wherein the conductive polymer composition has a conductivity of greater than about 450 siemens/cm.

36. A conductive polymer composition as defined in claim 31, wherein the conductive polymer composition has a conductivity of greater than about 600 siemens/cm.

37. A conductive polymer composition as defined in claim 31, wherein the conductive polymer composition has a conductivity of greater than about 750 siemens/cm.

38. A conductive polymer composition as defined in claim 31, wherein the conductive polymer composition has a visible light transmission level of greater than about 60%.

39. A conductive polymer composition as defined in claim 31, wherein the conductive polymer composition has a visible light transmission level of greater than about 70%.

40. A conductive polymer composition as defined in claim 31, wherein the conductive polymer composition has a visible light transmission level of greater than about 80%.

41. A conductive polymer composition as defined in claim 31, wherein the conductive polymer composition has a visible light transmission level of greater than about 90%.

42. A conductive polymer composition as defined in claim 31, wherein the metallic nanoparticles are formed from metal precursor salts containing a metal selected from the group consisting of Au, Ag, Pt, Pd, Cu, Ni, Al, and mixtures thereof.

43. A conductive polymer composition as defined in claim 31, wherein the metallic nanoparticles are formed from aggregates of metal ions selected from the group consisting of Au, Ag, Pt, Pd, Cu, Ni, and Al.

44. A conductive polymer composition as defined in claim 31, wherein the conductive polymer composition is a coating layer having an inner side and an outer side, and the inner side is bonded to a substrate.

45. A conductive polymer composition as defined in claim 44, further comprising a layer of antireflective material disposed upon the outer side of the coating layer.

46. A method for making a conductive polymer composition comprising:
a) combining an oxidized 3,4-ethylenedioxythiopene, a polysulfonated styrene, and a metallic nanoparticle precursor in a solvent system; and
b) adding a reducing agent.

47. A method for making a conductive polymer composition as defined in claim 46, wherein the reducing agent is selected from the group consisting of NaBH4, sodium citrate, hydrazine, hydroxylamine, dimethylformamide, lithium aluminum hydride, and mixtures thereof.

48. A method for making a conductive polymer composition as defined in claim 46, wherein the metallic nanoparticle precursor comprises a salt form of a metal selected from the group consisting of Au, Ag, Pt, Pd, Cu, Ni, Al, and mixtures thereof.

49. A method for making a conductive polymer composition as defined in claim 46, wherein the solvent system is selected from the group consisting of water, dimethylsulfone, ethylene glycol, dimethylformamide, dimethylacetamide, n-methyl pyrrolidone and mixtures thereof.

50. A conductive polymer composition comprising:
an oxidized 3,4-ethylenedioxythiopene polymer;
a polysulfonated styrene polymer;
metallic nanoparticles; and
single wall carbon nanotubes,
the polymers, metallic nanoparticles and single wall carbon nanotubes being combined such that the conductive polymer composition has a sheet resistance of less than about 200 Ohms/square, a conductivity of greater than about 300 siemens/cm, and a visible light transmission of greater than about 50% at a wavelength ranging from about 380 to 800 nm.

51. A conductive polymer composition as defined in claim 50, wherein the conductive polymer composition has a sheet resistance of less than about 175 Ohms/square.

52. A conductive polymer composition as defined in claim 50, wherein the conductive polymer composition has a sheet resistance of less than about 150 Ohms/square.

53. A conductive polymer composition as defined in claim 50, wherein the conductive polymer composition has a sheet resistance of less than about 100 Ohms/square.

54. A conductive polymer composition as defined in claim 50, wherein the conductive polymer composition has a conductivity of greater than about 450 siemens/cm.

55. A conductive polymer composition as defined in claim 50, wherein the conductive polymer composition has a conductivity of greater than about 600 siemens/cm.

56. A conductive polymer composition as defined in claim 50, wherein the conductive polymer composition has a conductivity of greater than about 750 siemens/cm.

57. A conductive polymer composition as defined in claim 50, wherein the conductive polymer composition has a conductivity of greater than about 900 siemens/cm.

58. A conductive polymer composition as defined in claim 50, wherein the conductive polymer composition has a visible light transmission level of greater than about 60%.

59. A conductive polymer composition as defined in claim 50, wherein the conductive polymer composition has a visible light transmission level of greater than about 70%.

60. A conductive polymer composition as defined in claim 50, wherein the conductive polymer composition has a visible light transmission level of greater than about 80%.

61. A conductive polymer composition as defined in claim 50, wherein the conductive polymer composition has a visible light transmission level of greater than about 90%.

62. A conductive polymer composition as defined in claim 50, wherein the metallic nanoparticles are formed from metal precursor salts containing a metal selected from the group consisting of Au, Ag, Pt, Pd, Cu, Ni, Al, and mixtures thereof.

63. A conductive polymer composition as defined in claim 50, wherein the metallic nanoparticles are formed from aggregates of metal ions selected from the group consisting of Au, Ag, Pt, Pd, Cu, Ni, Al, and mixtures thereof.

64. A conductive polymer composition as defined in claim 62, wherein the metal precursor salts are selected from the group consisting of AgNO₃, HAuCl₄, Na₂PtCl₄ and mixtures thereof.

65. A method for making a conductive polymer composition comprising:
a) combining an oxidized 3,4-ethylenedioxythiopene, a polysulfonated styrene, and a metallic nanoparticle precursor in a solvent system to form a mixture;
b) adding a reducing agent to the mixture to form metallic nanoparticles from the precursor, which are dispersed within a polymer matrix formed by the combination of the oxidized 3,4-ethylenedioxythiopene and the polysulfonated styrene;
c) adding single wall carbon nanotubes to the mixture containing the polymer matrix having metallic nanoparticles dispersed within; and
e) sonicating the mixture.

66. A method for making a conductive polymer as defined in claim 65, wherein metallic nanoparticle precursor is a metal salt comprising a metal selected from the group consisting of Au, Ag, Pt, Pd, Cu, Ni, Al, and mixtures thereof.

67. A method for making a conductive polymer as defined in claim 65, wherein the metallic nanoparticles are formed from aggregates of metal ions selected from the group consisting of Au, Ag, Pt, Pd, Cu, Ni and Al.

68. A method for making a conductive polymer as defined in claim 65, wherein the single wall carbon nanotubes are free of iron.

69. A method for making a conductive polymer as defined in claim 65, further comprising purifying the single wall carbon nanotubes prior to use using the steps of:
a) heating the single wall carbon nanotubes in an oxidizing atmosphere;
b) treating the single wall carbon nanotubes with a strong acid under sonication; and
c) washing the single wall carbon nanotubes.

70. A method for making a conductive polymer as defined in claim 69, wherein the single wall carbon nanotubes are heated to a static temperature of between about 200° C. and about 500° C.

71. A method for making a conductive polymer as defined in claim 69, wherein the single wall carbon nanotubes are heated from about 200° C. to about 500° C. using a heating ramp.

72. A method for making a conductive polymer as defined in claim 69, wherein the single wall carbon nanotubes are heated in an oxidizing atmosphere for between about 0.5 hours and about 4 hours.

73. A method for making a conductive polymer as defined in claim 69, wherein the single wall carbon nanotubes are sonicated for between about 0.5 hours and about 3 hours.

74. A method for making a conductive polymer as defined in claim 69, wherein the strong acid is selected from a group consisting of H₂SO₄, HNO₃, HCl, and mixtures thereof.

75. A method for making a conductive polymer as defined in claim 69, wherein the single wall carbon nanotubes are washed with an acid solution selected from the group consisting of H₂SO₄, HNO₃, HCl, and mixtures thereof.

76. A method for making a conductive polymer as defined in claim 69, wherein the single wall carbon nanotubes are washed with solvents selected from the group consisting of water, tetrahydrofuran, isopropyl alcohol, acetone, and mixtures thereof.

77. A method for making a conductive polymer as defined in claim 65, wherein the solvent system is selected from group consisting of water, dimethylsulfone, ethylene glycol, dimethylformamide, dimethylacetamide, n-methyl pyrrolidone and mixtures thereof.

78. A method for making a conductive polymer as defined in claim 65, wherein the single wall carbon nanotubes are functionalized by molecules selected from the group consisting of carboxyl, hydroxyl, hydrogen sulfite, nitrite, amine, and mixtures thereof.

79. A conductive polymer composition made by the method of claim 65, wherein the conductive polymer composition is a coating layer having an inner side and an outer side, and the inner side is bonded to a substrate.

80. A conductive polymer as defined in claim 79, further comprising a layer of anti-reflective material disposed upon the outer side of the coating.
